(19) United States
(12) Patent Application Publication
(10) Pub. No.: US 2013/0222747 A1
(43) Pub. Date: Aug. 29, 2013

(54) DISPLAY PANEL

(71) Applicants: Yuhko Hisada, Osaka-shi (JP); Hironobu Sawada, Osaka-shi (JP); Junichi Morinaga, Osaka-shi (JP); Katsushige Asada, Osaka-shi (JP); Ryohki Itoh, Osaka-shi (JP)

(72) Inventors: Yuhko Hisada, Osaka-shi (JP); Hironobu Sawada, Osaka-shi (JP); Junichi Morinaga, Osaka-shi (JP); Katsushige Asada, Osaka-shi (JP); Ryohki Itoh, Osaka-shi (JP)

(73) Assignee: SHARP KABUSHIKI KAISHA, Osaka-shi, Osaka (JP)

(21) Appl. No.: 13/883,069

(22) PCT Filed: Nov. 1, 2011
(86) PCT No.: PCT/JP2011/075154

§ 371 Date: May 2, 2013

(30) Foreign Application Priority Data
Nov. 9, 2010 (JP) 2010-251322

(51) Int. Cl. G02F 1/1343

(52) U.S. Cl. CPC G02F 1/13439
USPC 349/106; 349/139

(57) ABSTRACT

The present invention provides a display panel capable of suppressing display unevenness caused by the capacitance change due to misalignment when four primary colors are used. The display panel of the present invention includes: signal lines; pixel electrodes; and a common electrode. In the display panel, a single pixel is constituted by picture elements of four or more colors. Each of the pixel electrodes is connected to each one of the signal lines. The pixel electrodes, which are included in the single pixel, are arranged in a squared shape, and include a pixel electrode having larger area and a pixel electrode having smaller area. Both of a signal line connected to the pixel electrode having the larger area and a signal line connected to the pixel electrode having the smaller area overlap with the pixel electrode having the larger area.

### TECHNICAL FIELD

The present invention relates to a display panel. More specifically, the invention relates to a display panel in which each pixel is formed by using four or more multiple primary colors so as to be able to exhibit display characteristics such as a high luminance and a large color reproduction range.

### BACKGROUND ART

Recently, various types of display panels have been put into practical use, and a lot of products such as a mobile display panel and a large-size display panel have been provided. Among them, the liquid crystal display panel has features such as low power consumption and low weight based on a thin profile, and is thus applied to mobile applications, various monitors, televisions, and the like. Accordingly, the liquid crystal display panel is indispensable for daily life or business.

Conventionally, in order to display the colors of the display panel, the basic three primary colors formed of red (R), green (G), and blue (B) had been used. However, in recent years, techniques relating to the display apparatuses (mainly, TV sets, etc.), which use pixels with four or more multiple primary colors further including color units such as yellow (Y) and white (W) for the purpose of enhancement of the luminance, have been reported, and have been put into practical use.

As a driving method of the display panel, an active matrix driving method, in which an active element such as a thin film transistor (TFT) is disposed for each pixel so as to achieve a high image quality, has become widespread. For example, the liquid crystal display panel having TFTs may have the following configuration: signal lines and scanning lines are formed to intersect with each other, an active matrix substrate, in which the TFT and the pixel electrode are disposed for each intersection point, is provided, and a liquid crystal layer is sandwiched between the active matrix substrate and the counter substrate on which the common electrode is formed.

In such a liquid crystal display panel, the gate electrode of each TFT is connected to the scanning line, the source electrode is connected to the signal line, and the drain electrode is connected to the pixel electrode. Display ON and OFF can be controlled by flowing current from the signal line to the drain electrode in the ON state of the TFT, changing a voltage which is applied to the liquid crystal layer positioned between the pixel electrode and the common electrode, and adjusting the tilt of the liquid crystal molecules.

In such an active matrix driving method, a certain amount of a parasitic capacitance Csd is formed in a portion in which the signal line and the pixel electrode overlap with an insulation film interposed between therebetween. Even during a period in which the TFT is OFF, a voltage for supplying a signal to the pixel electrode is applied to the signal line. Hence, once the parasitic capacitance Csd is formed, the magnitude of the electric potential to be recorded into the pixel electrode is changed, and thus it is difficult to appropriately perform a desired display. Such change in the pixel potential has less effect on display unevenness when the change commonly occurs in each pixel electrode. However, for example, when there is misalignment between a layer on which the signal lines are formed and a layer on which the pixel electrodes are formed, an overlapping area, in which various wiring lines overlap with the pixel electrode, is set to be different for each pixel electrode. For this reason, the display unevenness tends to occur.

In order to cope with the above-mentioned problem, there is an attempt to contrive the following. Each of signal lines corresponding to two adjacent pixel electrodes disposed in parallel with a scanning line as counter parts is disposed on either one of the pixel electrodes. By placing the signal lines inside the edges of the pixel electrode, which is parallel with the signal lines, the change of the electric potential caused by overlapping the signal lines with the pixel electrode in a terminal connected to the pixel electrode during the period in which the TFT is OFF is suppressed as well as a large process margin is obtained (for example, refer to Patent Literature 1).

Further, there is an attempt to contrive the following wiring. The signal lines completely overlap with one of the pixel electrodes adjacent to each other such that the parasitic capacitance generated between each pixel electrode and each signal line is not changed even if there is misalignment during the manufacturing process, and each drain electrode is disposed around each pixel electrode and connected thereto, and the contact portion between the pixel electrode and the drain electrode overlaps with the scanning line at the former row (for example, refer to Patent Literature 2).

### CITATION LIST

### Patent Literature

Patent Literature 1: JP-A-2005-99733
Patent Literature 2: JP-A-2005-173613

### SUMMARY OF INVENTION

### Technical Problem

FIG. 21 is a schematic plan view illustrating a conventional display panel using three primary colors. FIG. 22 is a schematic plan view illustrating a conventional display panel using four primary colors. The region surrounded by the dotted line in FIGS. 21 and 22 represents a single pixel, and the single pixel is constituted by three or four picture elements. As shown in FIGS. 21 and 22, an exemplary conventional display panel is configured such that the pixel electrodes 111 are arranged in matrix, each source bus line (signal line) 112, through which an image signal is sent to each pixel electrode 111, are partially curved, and each source bus line 112 is disposed to overlap with each adjacent pixel electrode 111. A parasitic capacitance Csd is formed at a position where each pixel electrode 111 and each source bus line 112 overlap with each other with an insulation film interposed therebetween. However, by forming the source bus line 112 in a staggered shape, the overlapping areas between the source bus lines 112 and the pixel electrodes 111 are not so greatly changed between the adjacent picture elements even if there is misalignment between the source bus lines 112 and the pixel electrodes 111. As a result, it is possible to effectively reduce display unevenness.

However, in such a display panel of the conventional design, particularly, when multiple primary colors are used for a high-definition display panel, a sufficient margin is not taken, and thereby it is concerned about a yield ratio. Furthermore, it is also concerned that luminance unevenness due to so-called block division or scan unevenness tends to be observed if the parasitic capacitance changes depending on variations in finishing quality, such as changes in the line width of the wiring pattern and local misalignment in the manufacturing process in such a display panel.

The reason of occurrence of the luminance unevenness is considered as follows. First, if variations in finishing quality are caused by misalignment and the like, the overlapping area between the source bus line and the pixel electrode may be partially changed. In accordance therewith, the parasitic capacitance Csd is changed. Further, even if the overlapping area between the source bus line and the pixel electrode is not changed, the magnitude of the parasitic capacitance Csd is small, but changed. The reason is that, for example, the distance between the source bus line and the edge of the pixel electrode is changed.

Further, in particular, when a high-definition model in which picture element areas are small is used, by using multiple primary colors which are four or more colors instead of three colors, the area per one picture element is significantly lowered. Hence, the total capacitance of the pixel electrodes in a single pixel is inevitably lowered. In contrast, the capacitance (Csd) between the pixel electrode and the source bus line is substantially constant compared with the capacitance in the case where the four or more multiple primary colors are not used, and the capacitance change (ΔCsd) in the case where there is local misalignment is also constant. As a result, the change ratio of the capacitance of each pixel electrode to the total capacitance of the pixel electrodes in a single pixel in the case where there is misalignment when using four or more multiple primary colors is large compared with the model using three primary colors. Specifically, when three colors are changed to four colors, the effect of misalignment becomes great by about 1.5 times.

That is, as the total capacitance per one pixel becomes smaller, the change in Csd caused by misalignment tends to have a greater effect, and thus the effect of the change in luminance caused by the change in Csd is more remarkably observed.

The present invention has been made in view of the above-mentioned situation, and its object is to provide a display panel capable of suppressing display unevenness caused by the capacitance change due to misalignment when four primary colors are used.

### Solution to Problem

Inventors of the present invention studied the problems in the case where multiple primary colors which are four colors are used instead of three primary colors, and focused on the fact that there are two factors. One factor is a difference (ΔΔVdr) between the lead-in voltages (ΔVdr) of a misaligned portion and a normal portion generated by the misalignment. If this factor is large, the pixel potential is different for each region. For this reason, when a gray scale is displayed, luminance unevenness is caused by the difference, and observed. The other factor is a ratio (Csd/Cpix) of the capacitance between the pixel electrode and the source bus line to the total capacitance. If this factor is large, it is difficult to obtain a desired pixel potential. For this reason, in particular, when a monochromatic and complementary color is displayed, luminance change or tinge shift is observed.

As a result of a keen examination, the inventors of the present invention found that it is possible to achieve a high-quality display in which the luminance unevenness, luminance change, and tinge shift are small, in the following manner. In a layering method of overlapping the pixel electrodes and the source bus lines, the pixel electrodes are arranged in a squared shape. The areas of the pixel electrodes arranged in the row direction are set to be different from one another. The source bus lines connected to one picture element (self-picture element) and a picture element (another picture element) adjacent thereto respectively overlap with a pixel electrode having larger area. Thereby, the change (ΔΔVdr) in the lead-in voltage caused by misalignment and the ratio (Csd/Cpix) of the magnitude of the capacitance between the pixel electrode and the source bus line to the magnitude of the total capacitance is suppressed. Accordingly, considering that the above-mentioned problem can be solved in such a manner, the inventors contrived the present invention.

That is, in the present invention, a display panel includes: signal lines; pixel electrodes; and a common electrode, wherein a single pixel is constituted by picture elements of four or more colors, wherein each of the pixel electrodes is connected to each one of the signal lines, wherein the pixel electrodes, which are included in the single pixel, are arranged in a squared shape, and include a pixel electrode having larger area and a pixel electrode having smaller area, and wherein both of a signal line connected to the pixel electrode having the larger area and a signal line connected to the pixel electrode having the smaller area overlap with the pixel electrode having the larger area. Hereinafter, the display panel according to the present invention will be described in detail.

The display panel according to the present invention includes: signal lines; pixel electrodes; and a common electrode, wherein a single pixel is constituted by picture elements of four or more colors. Each of the pixel electrodes is connected to each one of the signal lines. By connecting the signal lines to the pixel electrodes, it is possible to perform control to apply a voltage between the common electrode and each pixel electrode. Further, it is possible to adjust the color display for each pixel in such a manner, and thus it is possible to perform a high-definition display. In the present invention, since the number of colors of the picture elements is four or more, compared with the general three-color display panel, it is possible to enhance the luminance and expand the color reproduction range.

The pixel electrodes, which are included in the single pixel, are arranged in a squared shape. In the present description, a “squared array” means an array in which plural objects are arranged in each of the row direction and the column direction. The number of objects arranged in the row direction may coincide or may not coincide with the number of objects arranged in the column direction. Thereby, even when the pixels are formed in a high resolution, for example, compared with a stripe array in which different color picture elements are unidirectionally arranged, it is possible to decrease the overlapping areas between the pixel electrodes and the signal lines in a single pixel, and thus it is possible to decrease the magnitude of the capacitance itself formed between each pixel electrode and each signal line. Therefore, it is possible to reduce the tinge shift when a monochromatic or complementary color is displayed. At the same time, it is possible to reduce an amount of change in the lead-in voltage caused by using four primary colors instead of three primary colors, and thus it is possible to reduce luminance unevenness. Further, since there is a margin even in the width of each picture element, it is possible to secure a sufficient margin, and thus the yield ratio is improved.

The pixel electrodes, which are included in the single pixel, are arranged in a squared shape, and include a pixel electrode having larger area and a pixel electrode having smaller area, and both of a signal line connected to the pixel electrode having the larger area and a signal line connected to the pixel electrode having the smaller area overlap with the pixel electrode having the larger area. Here, the terms “larger” and “smaller” are used for the two pixel electrodes which are arbitrarily selected from four or more electrodes. Accordingly, different signal lines are respectively connected to these two pixel electrodes which are arbitrarily selected from the four or more electrodes. As described above, by integrating the signal lines on one of the pixel electrodes, it is possible to decrease the difference (ΔΔVdr) between the lead-in voltages of the misaligned portion and the normal portion caused by misalignment, and thus it is possible to reduce luminance unevenness.

As described above, according to the present invention, by using four primary colors, the effects of high luminance and wide color reproduction range are obtained, and both of luminance unevenness, which is caused by misalignment, and tinge shift, which is caused when the monochromatic or complementary color is displayed, are reduced at one time. Thereby, it is possible to provide a display panel capable of exhibiting excellent display quality.

The configuration of the display panel of the present invention is not especially limited by other components as long as it essentially includes such components.

Hereinafter, preferred embodiments of the present invention will be described in detail.

It is preferable that a polarity of an electric potential of the pixel electrode having the larger area and a polarity of an electric potential of the pixel electrode having the smaller area be opposite to each other with reference to an electric potential of the common electrode. With such a configuration, it is possible to prevent a vertical shadow from occurring, and thus it is possible to improve the display quality.

It is preferable that the pixels be formed in matrix on the display panel, and respective electric potentials of the pixel electrodes, which are included in the single pixel of the pixels and are adjacent in a row direction, be different from respective electric potentials of the pixel electrodes at the same positions included in a pixel adjacent to the single pixel, with reference to the electric potential of the common electrode. With such a configuration, it is possible to prevent a horizontal shadow from occurring, and thus it is possible to enhance the display quality.

It is preferable that the pixels be formed in matrix on the display panel, and any of electric potentials of the pixel electrodes, which are included in the single pixel of the pixels, be different from electric potentials of the pixel electrodes at the same positions included in a pixel adjacent to the single pixel respectively, with reference to the electric potential of the common electrode. Thereby, it is possible to prevent both of vertical shadow and horizontal shadow from occurring, and thus it is possible to significantly improve the display quality.

It is preferable that a length of a portion, in which at least one of the signal lines overlaps with one of the pixel electrodes, be shorter than a length of a longest portion of the pixel electrode in the same direction. With such a configuration, it is possible to decrease the parasitic capacitance (Csd) formed between each pixel electrode and each signal line. Hence, it is possible to effectively suppress luminance deterioration and tinge shift, which occurs when the monochromatic or complementary color is displayed, and luminance unevenness which is caused in the manufacturing process, and it is possible to perform a high-quality display.

It is preferable that the number of the pixel electrodes, which are included in the single pixel, is 2n (n is a natural number), and the pixel electrodes be formed of n pixel electrodes having the larger areas and n pixel electrodes having the smaller areas, the n pixel electrodes having the larger areas be arranged in the same direction, and the n pixel electrodes having the smaller areas be arranged in a direction different from that of the n pixel electrodes having the larger areas. That is, the embodiment is an embodiment in which the areas of the pixel electrodes included in the single pixel are classified into only two types of large and small areas. Thereby, it is possible to obtain effects of the present invention with the simplest configuration. Further, the signal lines are linearly formed in the column direction, and thus this configuration is made to be simple.

It is preferable that the number of the pixel electrodes, which are included in the single pixel, be 2n (n is a natural number), and the pixel electrodes be formed of n pixel electrodes having the larger areas and n pixel electrodes having the smaller areas, and the n pixel electrodes having the larger areas and the n pixel electrodes having the smaller areas be arranged in a checkered pattern shape in a row direction and a column direction. That is, the embodiment is an embodiment in which the areas of the pixel electrodes included in the single pixel are classified into only two types of larger and smaller areas. With such a configuration, it is also possible to sufficiently obtain effects of the present invention.

It is preferable that color filters be respectively formed to overlap with the pixel electrodes, and a magnitude of a luminosity of a color of the color filter, which overlaps with the pixel electrode having the larger area be smaller than a magnitude of a luminosity of a color of the color filter which overlaps with the pixel electrode having the smaller area, in the single pixel. With such a configuration, even when an aperture ratio of each pixel electrode having the larger area are set to be larger, the effect of luminance unevenness is suppressed, and this hardly leads to deterioration in the display quality.

It is preferable that the color filters be respectively formed to overlap with the pixel electrodes, and an actual aperture area of the color filter, which overlaps with the pixel electrode having the larger area be substantially the same as an actual aperture area of the color filter which overlap with the pixel electrode having the smaller area, in the single pixel. In the present description, the “actual aperture area” means an area (an area of a region through which light is transmitted) obtained by subtracting the area of the region, in which the light shielding members such as the black matrix and wiring lines are disposed, from the area of the color filters. Considering the balance between tinge in practical use and securing of luminance, this ratio is most preferred. In particular, in the mobile application focusing on luminance, the present embodiment is preferred. From the same viewpoint, it is more preferable that each of the actual aperture areas of the color filters, which overlap with each of the pixel electrodes be substantially the same, in the single pixel.

It is preferable that the display panel be a liquid crystal display panel including a pair of substrates, which are formed of an active matrix substrate and a counter substrate, and a liquid crystal layer which is sandwiched between the pair of substrates. The present invention is appropriately used in reverse polarity driving, and is thus appropriately used in particularly the liquid crystal display panel.

### Advantageous Effects of Invention

According to the display panel of the present invention, it is possible to sufficiently suppress display unevenness caused by the capacitance change due to misalignment by using four primary colors.

### BRIEF DESCRIPTION OF DRAWINGS

FIG. 1 is a schematic plan view illustrating a structure of an active matrix substrate of a display panel according to Embodiment 1.

FIG. 2 is a schematic plan view illustrating a color arrangement of the display panel according to Embodiment 1.

FIG. 3 is a schematic plan view illustrating light shielding regions of the display panel according to Embodiment 1.

FIG. 4 is a schematic plan view illustrating polarities of electric potentials of pixel electrodes of the active matrix substrate of the display panel according to Embodiment 1, with reference to the electric potential of the common electrode.

FIG. 5 is a waveform chart illustrating a signal waveform of a source signal and a signal waveform of a pixel electrode A in the case of monochromatic display.

FIG. 6 is a schematic plan view illustrating a wiring structure of an active matrix substrate of a display panel according to Embodiment 2.

FIG. 7 is a schematic plan view illustrating a color arrangement of the display panel according to Embodiment 2.

FIG. 8 is a schematic plan view illustrating light shielding regions of the display panel according to Embodiment 2.

FIG. 9 is a schematic plan view illustrating a wiring structure of an active matrix substrate of a display panel according to Embodiment 3.

FIG. 10 is a schematic plan view illustrating a wiring structure of an active matrix substrate of a display panel according to Embodiment 4.

FIG. 11 is a schematic plan view illustrating an example of a wiring structure of an active matrix substrate of a display panel according to Example 1.

FIG. 12 is a schematic plan view illustrating an example of a wiring structure of an active matrix substrate of a display panel according to Example 2.

FIG. 13 is a schematic plan view illustrating an example of a wiring structure of an active matrix substrate of a display panel according to Example 3.

FIG. 14 is a schematic plan view illustrating an example of a wiring structure of an active matrix substrate of a display panel according to Example 4.

FIG. 15 is a schematic plan view illustrating an example of a wiring structure of an active matrix substrate of a display panel according to Reference Example 1.

FIG. 16 is a schematic plan view illustrating an example of a wiring structure of an active matrix substrate of a display panel according to Reference Example 2.

FIG. 17 is a schematic plan view illustrating an example of a wiring structure of an active matrix substrate of a display panel according to Reference Example 3.

FIG. 18 is a schematic plan view illustrating an example of a wiring structure of an active matrix substrate of a display panel according to Reference Example 4.

FIG. 19 is a schematic plan view illustrating an example of a wiring structure of an active matrix substrate of a display panel according to Reference Example 5.

FIG. 20 is a graph of the result of Table 2.

FIG. 21 is a schematic plan view illustrating a conventional display panel using three primary colors.

FIG. 22 is a schematic plan view illustrating a conventional display panel using four primary colors.

### DESCRIPTION OF EMBODIMENTS

The present invention will be mentioned in more detail referring to the drawings in the following embodiments, but is not limited to these embodiments.

The display panel according to the present invention is particularly useful for a display device having small picture elements, and is appropriately used for a middle-sized mobile display panel such as an electronic book, a photo frame, IA (Industrial Appliance), or a PC (personal computer).

In the present description, the order of the magnitudes of the luminosities of the respective colors depends on the Y value of the Yxy color specification system. For example, if the respective colors of red (R), green (G), blue (B), yellow (Y), white (W), magenta (M), and cyan (C) are arranged in descending order of the respective luminosities, the colors are arranged in the following order: white (W)>yellow (Y)>cyan (C)>green (G)>magenta (M)>red (R)>blue (B).

Examples of the display panels, to which the present invention can be applied, include a liquid crystal display panel (LCD), an electroluminescence display panel (EL), and the like.

In the description, “substantially” is defined to include those which may be regarded as substantially the same. If it applies to a numerical value, the value is defined to have a tolerance within 10% relative to the entire range.

### Embodiment 1

The display panel according to Embodiment 1 is a liquid crystal display panel including: a pair of substrates between which a space is held by photo spacers; and a liquid crystal layer which is sealed between the pair of substrates. One substrate of the pair of substrates constitutes an active matrix substrate including thin film transistors (TFT: Thin Film Transistor), gate bus lines (scanning lines), source bus lines (signal lines), pixel electrodes, interlayer insulation films that electrically isolates the various lines and electrodes, and an alignment film which gives an orientation to the liquid crystal molecules. The other substrate of the pair of substrates constitutes a color filter substrate including color filters, a black matrix, a common electrode, and an alignment film which gives an orientation to the liquid crystal molecules.

The pixel electrodes are arranged in matrix. Each region, in which each pixel electrode is positioned, corresponds to one picture element, and a single pixel is constituted by picture elements. That is, the region, in which four pixel electrodes formed in a squared shape are disposed, constitutes the single pixel. Further, the color filters, which are provided on the other substrate, are disposed to respectively overlap with the pixel electrodes, and are thus arranged in a squared shape like the pixel electrodes. The color filters are divided by the black matrix. In the present description, when the color filters are separated by the black matrix and the color filters having the same color are arranged next to each other, the color filters are regarded as separated color filters.

In Embodiment 1, the color filters arranged in a squared shape have different colors from each other, but kinds of the colors and order of the arranged colors are not particularly limited. For example, a combination of red (R), green (G), blue (B), and yellow (Y), or a combination of red (R), green (G), blue (B), and white (W) may be used. When four colors are used by adding a single color to three colors of red (R), green (G), and blue (B), if priority is placed on the luminance, it is preferable that the single color be white (W), and if priority is placed on the color reproduction range, it is preferable that the single color be yellow (Y). In the present description, the color filter of white (W) is defined as a colorless and transparent color filter.

A liquid crystal alignment mode of the liquid crystal display panel according to Embodiment 1 is not particularly limited, and it is possible to employ a TN (Twisted Nematic) mode, an STN (Super Twisted Nematic) mode, a VA (Vertical Alignment) mode, a MVA (Multi-domain Vertical Alignment) mode, a CPA (Continuous Pinwheel Alignment) mode, an IPS (In-plane Switching) mode, FFS (Fringe Field Switching) mode, a TBA (Transverse Bend Alignment) mode, and the like. Since the picture elements are constituted in a squared array, in the case the single pixel is divided into multiple domains, it is preferable to employ the CPA mode in which dot-like rivets as projections or electrode holes are provided for alignment control of the liquid crystal on the color filter substrate so as to control alignment of the liquid crystal molecules.

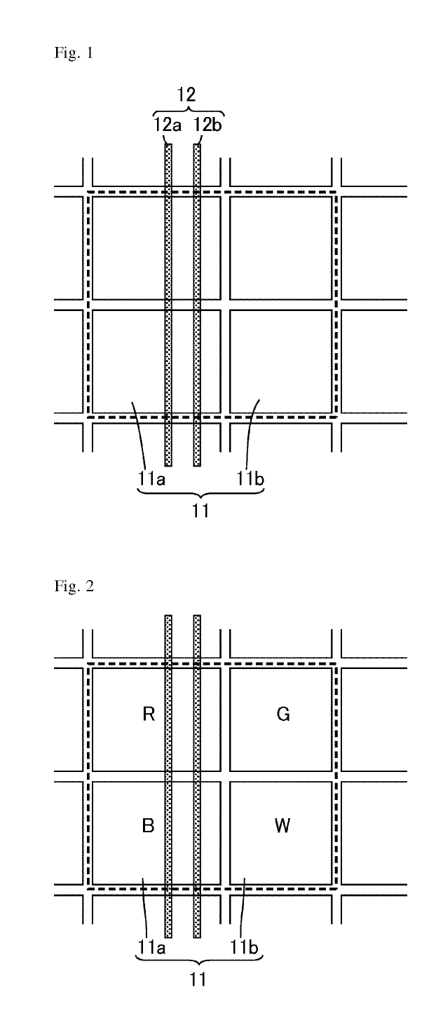

FIG. 1 is a schematic plan view illustrating a structure of the active matrix substrate of the display panel according to Embodiment 1. As shown in FIG. 1, pixel electrodes 11 are arranged in matrix, and source bus lines 12, through which image signals are sent to pixel electrodes 11, linearly extend in the column direction. A single pixel is a region (the portion surrounded by the dotted line of FIG. 1) in which four pixel electrodes 11 arranged in a squared shape are positioned, and two types (2n total) of large and small pixel electrodes 11 are disposed in the single pixel.

The areas of the two pixel electrodes 11, which are arranged in the column direction, among the four pixel electrodes 11, which are arranged in a squared shape, are substantially the same. On the other hand, the areas of the two pixel electrodes 11, which are arranged in the row direction, among the four pixel electrodes 11, which are arranged in a squared shape, are different each other. In the example shown in FIG. 1, each of the two pixel electrodes 11a in the left column are larger than each of the two pixel electrodes 11b in the right column.

In Embodiment 1, one source bus line 12 is connected to each of the pixel electrodes 11a arranged in one of the columns. The source bus line 12a, which is connected to each of pixel electrodes 11a having larger areas among the pixel electrodes 11 arranged in a squared shape, is formed so as to overlap with the pixel electrodes 11a having the larger areas. The source bus line 12b, which is connected to each of pixel electrodes 11b having smaller areas, is also formed so as to overlap with the pixel electrodes 11a having the larger areas.

FIG. 2 is a schematic plan view illustrating a color arrangement of the display panel according to Embodiment 1. In Embodiment 1, the color filters and common electrode are formed on the side of the substrate which is opposed to the active matrix substrate with the liquid crystal layer interposed therebetween. As a modified example, a structure, in which the color filters and/or the common electrode are formed on the active matrix substrate, may be adopted. As shown in FIG. 2, the color filters are disposed such that the color filters of red (R) and blue (B) overlap with the pixel electrodes 11a having the larger areas among the four pixel electrodes 11 arranged in a squared shape and the color filters of green (G) and white (W) overlap with the pixel electrodes 11b having the smaller areas among the four pixel electrodes 11.

Thereby, among the pixel electrodes arranged in a squared shape, the pixel electrode 11a included in the picture element of red (R) and the pixel electrode 11a included in the picture element of blue (B) are connected to the same source bus line 12a, and the pixel electrode 11b included in the picture element of green (G) and the pixel electrode 11b included in the picture element of white (W) are connected to the same source bus line 12b.

In Embodiment 1, the color filters of red (R) and blue (B) are repeatedly arranged along one column regardless of division of pixels, and the color filters of green (G) and white (W) are repeatedly arranged along the other column.

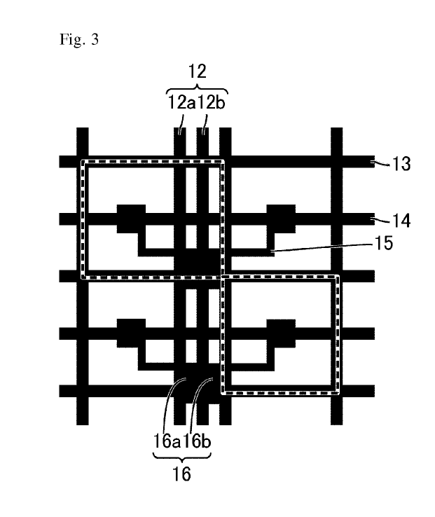

FIG. 3 is a schematic plan view illustrating light shielding regions of the display panel according to Embodiment 1. The light shielding region means, specifically, a region in which the black matrix is provided on the color filter substrate, or a region in which various lines are provided on the active matrix substrate. In addition, regions (regions other than the solid black portions) other than such light shielding regions are aperture regions of the color filters. The source bus lines 12 are connected to the pixel electrodes through the TFTs 16, and the light shielding regions (black matrix) in a certain range for covering the TFTs 16 is formed in a region adjacent to the source bus lines 12. Further, a drain wiring line 15 extends from the TFT 16 toward the center of the picture element, and a connection point between the line and the pixel electrode is formed with the extent of a certain range at the center of the picture element. Therefore, the light shielding region is formed in a shape according to the region in which the drain wiring line 15 is formed. Further, two source bus lines 12 extend in the picture elements of the larger areas, and thus the two light shielding regions are formed in each picture element along the regions in which the source bus lines 12 are disposed. Furthermore, the gate bus lines 13 extend in the row direction on the gaps between the pixel electrodes arranged in the column direction. These regions also form light shielding regions. Further, auxiliary capacitance wiring lines (CS bus lines) 14 extend in the same direction at positions between the gate bus lines 13 which extend in the row direction. The light shielding regions are formed along the regions in which these lines are disposed.

As shown in FIG. 3, all the patterns of such light shielding regions are formed to be the same in the picture elements arranged in the same column. That is, the same patterns of the wiring lines and electrodes are repeated for the picture elements arranged in the column direction. Further, in the picture elements adjacent in the row direction, the extension directions of the drain wiring lines, which extend from the TFT toward the centers of the picture elements, are opposite. In other words, the structures of the drain wiring lines and the other wiring lines disposed in the picture elements are substantially symmetric to each other about the axis of the border lines of the picture elements extending in the column direction.

In Embodiment 1, the pixel electrodes with different areas are disposed in the single pixel, and thus the areas of the picture elements are different. However, as can be seen from FIG. 3, in the picture elements with different areas, the total areas of the light shielding regions are also different. Thus, the actual aperture areas of the picture elements are adjusted to be substantially 1:1:1:1 as a whole. By performing adjustment in such a manner, it is possible to obtain both effects of enhancement of luminance in the case of employing a color with high luminance and an increase in the color reproduction range in a balanced manner. When priority is placed on securing of luminance, it may be possible to make the actual aperture area different for each picture element such as to enhance the aperture ratio of the color with high luminosity, and it may be possible to appropriately change the design.

As described above, in the configuration of Embodiment 1, the arrangement of the pixel electrodes in the single pixel is set as the squared array, and the source bus lines are integrated on the pixel electrodes in one column. In such a manner, it is possible to reduce the effect of the change in the lead-in voltage at the time of reverse polarity driving Thus, it is possible to not only suppress luminance unevenness, which is caused in the manufacturing process, but also achieve a high-quality display in which deterioration in luminance and tinge shift are unlikely to occur when a monochromatic or complementary color is displayed.

Hereinafter, a principle capable of obtaining these effects will be described in further detail.

FIG. 4 is a schematic plan view illustrating polarities of electric potentials of pixel electrodes of the active matrix substrate of the display panel according to Embodiment 1, with reference to the electric potential of the common electrode. As shown in FIG. 4, the pixel electrodes have + polarities in one column of the squared array, and the pixel electrodes have −polarities in the other column. In the example shown in FIG. 4, in the upper side pixel, the two pixel electrodes in the left side column have +, and the two pixel electrodes in the right side column have −. Further, in the lower side pixel, the two pixel electrodes in the left side column have −, and the two pixel electrodes in the right side column have +. As described above, the display panel according to Embodiment 1 employs reverse polarity driving methods of a (line reversal) type in which a polarity is set to be different for each column and a (dot reversal) type in which a polarity is set to be different for each pixel, and thus the panel has a mechanism (driver) capable of performing such control. The line A of FIG. 4 indicates the bus line connected to each of the pixel electrodes positioned in the left side column. The line B of FIG. 4 indicates the bus line connected to each of the pixel electrodes positioned in the right side column.

Here, it is assumed that the capacitance formed between the gate bus line and the pixel electrode is Cgd, the capacitance (S-to-D capacitance) formed between the source bus line and the pixel electrode is Csd, the auxiliary capacitance formed between the CS bus line and the pixel electrode is Ccs, and the liquid crystal capacitance formed between the pixel electrode and the common electrode is Clc. Under the assumption, the pixel electrode capacitance Cpix is represented by Cgd+Csd+Ccs+Clc obtained by adding them to one another.

Further, it is assumed that the S-to-D capacitance is divided into Csd1 formed between the self-pixel (left side column) electrodes and the bus line (line A) for driving self-pixel electrodes and Csd2 formed between the bus line (line B) for driving other pixel (right side column) electrodes and the self-pixel electrodes. In addition, it is assumed that a value, which is obtained by subtracting the unchanged electric potential of the bus line for driving the self-pixel electrodes from the changed electric potential thereof, is ΔVs1, and a value, which is obtained by subtracting the unchanged electric potential of the bus line for driving other pixel electrodes from the changed electric potential thereof, is ΔVs2. Under the assumption, the lead-in voltage ΔVdr in gray display is represented by

ΔVdr=(Csd1/Cpix)*ΔVs1−(Csd2/Cpix)*ΔVs2 [Expression 1].

From this, when a polarity of the signal voltage for driving the self-pixels and a polarity of the signal voltage for driving the other pixels are opposite and the condition of ΔVs1=ΔVs2=ΔVs (gray display) is satisfied, the lead-in voltage ΔVdr in gray display is represented by

ΔVdr={(Csd1−Csd2)/Cpix}*ΔVs [Expression 2].

When there is misalignment between the source bus lines (source layer) and the pixel electrodes (pixel electrode layer) in the manufacturing process, the value of (Csd1−Csd2) in [Expression 2] is changed, and thus display unevenness in gray display is observed. Here, if the change in ΔVdr caused when there is misalignment is represented by a misalignment coefficient (ΔΔVdr), ΔΔVdr is represented as follows:

ΔΔVdr=|ΔVdr(aligned portion)−ΔVdr(misaligned portion) [Expression 3].

The misalignment coefficient (ΔΔVdr) is more remarkable when the four primary colors are used instead of three primary colors. For example, when a combination of stripes of red (R), green (G), and blue (B) is changed into a combination of stripes of red (R), green (G), blue (B), and yellow (Y), if the area ratio of the colors is set to 1:1:1:1, each picture element size is ¾ times the size in the case of using three primary colors (considering the gaps between the pixel electrodes, the difference therebetween further increases). In contrast, since the values of Csd1 and Csd2 are invariant, the value of the misalignment coefficient (ΔΔVdr) is 1.3 to 1.5 times the coefficient in the case where the four primary colors are not used. As a result, display unevenness tends to be observed.

Further, particularly in the case of the monochromatic display or complementary color display, the effective values of the pixel electrodes are changed by the effect of the signals of the signal lines on the basis of Csd1 and Csd2, and thus deterioration in luminance and tinge shift occur.

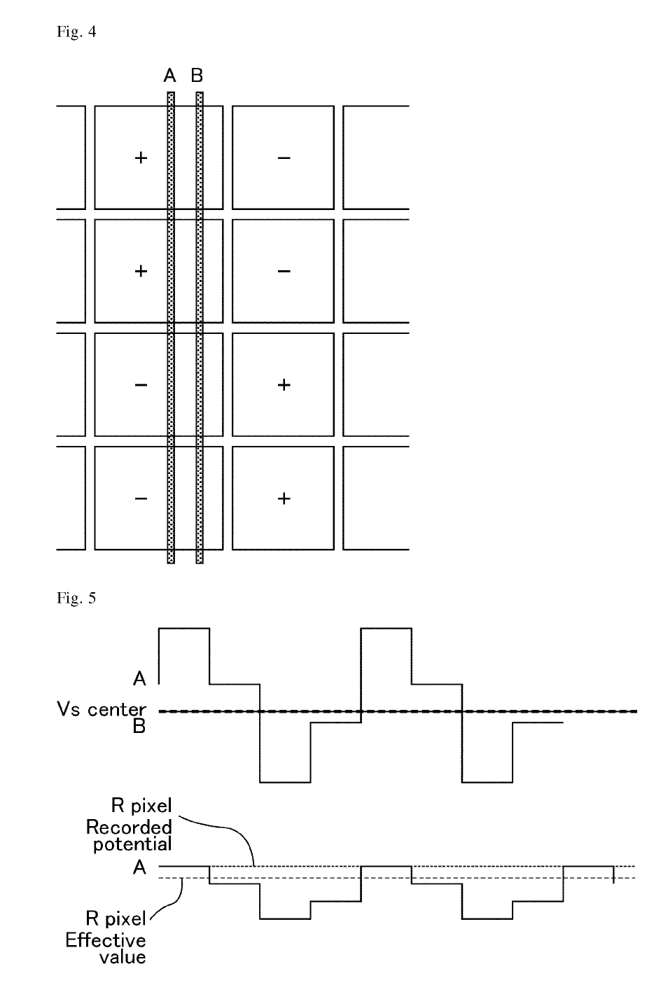

For example, in the case of the monochromatic display, the effective value of the upper left pixel electrode (hereinafter referred to as a pixel electrode A) of the squared array shown in FIG. 4 is significantly reduced mainly by the effect of Csd1. FIG. 5 is a waveform chart illustrating a signal waveform of the source signal (line A and line B) and a signal waveform of the pixel electrode A in the case of the monochromatic display.

As shown in FIG. 5, the drain electric potential of the pixel electrode A is changed four times during a single frame. It is assumed that the changes in the source electric potential are ΔVa1 to ΔVa4, and the changes in the drain electric potential of the pixel electrode A corresponding thereto are ΔVb1 to ΔVb4. Under the assumption, ΔVb1 to ΔVb4 are respectively represented by ΔVb1=ΔVa1×Csd1/Cpix, ΔVb2=ΔVa2×Csd1/Cpix, ΔVb3=ΔVa3×Csd1/Cpix, and ΔVb4=ΔVa4×Csd1/Cpix. The average of the drain electric potentials, which are actually observed, is equal to the average (the mean square based on time) of the effective values which has been affected by these changes. Therefore, as shown in FIG. 5, all the electric potentials are reduced compared with the electric potentials actually recorded in the pixel electrodes A. As a result, the actual display luminance is reduced compared with the luminance to be originally displayed.

Further, in the case of the complementary color display, the effective values are increased or decreased by not only the effect of Csd1 but also the effect of Csd2 for each color, and thus the tinge is changed.

Accordingly, in order to minimize the change in the misalignment coefficient, the deterioration in monochromatic luminance, and the tinge shift, in Embodiment 1, the following contrivance is made: the array of the pixel electrodes in the single pixel is set as the squared array, the size of the pixel electrode is set to be different for each column, and the source bus lines of the self-pixels and the other pixels are integrated on the pixel electrodes having the larger areas.

The entire two source bus lines are disposed to overlap with the pixel electrodes having larger areas, and signals having polarities opposite to each other are given, whereby ΔΔVdr becomes equal to a value which is almost negligible. Consequently, it is possible to sufficiently secure the process margin, and it is possible to achieve a high-quality display in which display unevenness is small.

Further, if the picture elements for each single pixel are not arranged in a conventional stripe shape, but arranged in a so-called squared shape, the values of Csd1/Cpix and Csd2/Cpix can be suppressed equally to the case where the four primary colors are used. Hence, in either case of the monochromatic color and the complementary color, it is possible to achieve a high-quality display in which luminance is reduced and tinge shift is small. Further, by employing such a squared array, the total length of the source bus line passing through the single pixel can be reduced, and the value of ΔΔVdr can be suppressed to ½. In such a manner, it is possible to achieve a high-quality display in which deterioration in luminance and tinge shift in the case of the monochromatic and complementary color display and the luminance unevenness caused in the manufacturing process do not occur.

In addition, in Embodiment 1, assuming that the electric potential difference between the gate bus lines at the time of driving the display panel is vg^{p-p}, it is preferable that at least one of the value which is calculated by the lead-in voltage of the gate bus line ΔVd=(Cgd/(Cgd+Csd1+Csd2+Ccs+Clc))×v^{p-p}, the difference Ω in the value of ΔVd between the white display and the black display, and Ccs/Clc be substantially the same for each picture element. Examples of such an adjustment method include a method of making the overlapping area of the TFT different for each picture element and a method of making the overlapping area of the CS bus line for each picture element. As described above, by not making a difference in the optimum counter voltage and the ratio of auxiliary capacitance according to the picture element, it is possible to obtain an excellent display quality panel without image sticking and the like. The electric potential difference vg^{p-p} between the gate bus lines is represented by |Vgh−Vgl| (Vgh represents a highest voltage in the scanning line when the TFT is turned on or off. Vgl represents a lowest voltage in the gate bus line). Further, the difference Ω in ΔVd between the white display and the black display is a difference in the ΔVd value between the white display and the black display caused by the difference in the liquid crystal capacitance between the white display and the black display. The difference is calculated by the following expression: Ω=|ΔVd (black)−ΔVd (white) |Cgd/(Cgd+Csd+Ccs+Clc (black))Δv^{p-p}−Cgd/(Cgd+Csd+Ccs+Clc (white))×v^{p-p}|. The Clc (black) means Clc in the case of the black display, and the Clc (white) means Clc in the case of the white display.

### Embodiment 2

A display panel according to Embodiment 2 is the same as the display panel according to Embodiment 1 except that the source bus lines, the TFTs, and the spacers are differently positioned.

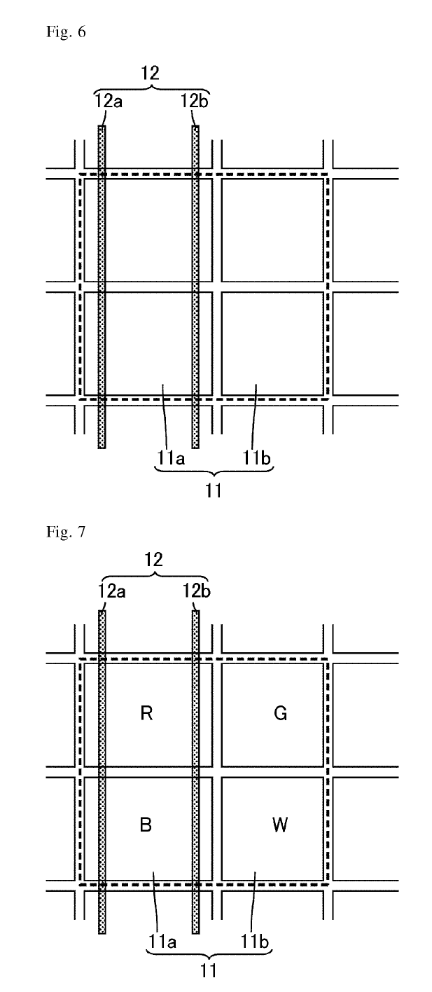

FIG. 6 is a schematic plan view illustrating a wiring structure of the active matrix substrate of the display panel according to Embodiment 2. As shown in FIG. 6, pixel electrodes 11 are arranged in matrix, and source bus lines 12, through which image signals are sent to pixel electrodes 11, linearly extend in the column direction. A single pixel is a region (the portion surrounded by the dotted line of FIG. 6) in which four pixel electrodes 11 arranged in a squared shape are positioned, and two types (2n total) of large and small pixel electrodes 11 are disposed in the single pixel.

In Embodiment 2, the gap between the source bus lines 12 is increased compared with the case of Embodiment 1. As described above, the entireties of the source bus lines 12 in the widthwise direction of the line may overlap with the pixel electrodes 11, and the design thereof may be appropriately changed in accordance with the positions of the members for which light is blocked by the black matrix such as TFTs and spacers.

FIG. 7 is a schematic plan view illustrating a color arrangement of the display panel according to Embodiment 2. As shown in FIG. 7, the color filters are disposed such that the color filters of red (R) and blue (B) overlap with the pixel electrodes 11a having the larger areas among the four pixel electrodes 11 arranged in a squared shape and the color filters of green (G) and white (W) overlap with the pixel electrodes 11b having the smaller areas among the four pixel electrodes 11 arranged in a squared shape.

Thereby, among the pixel electrodes arranged in a squared shape, the pixel electrode 11a included in the picture element of red (R) and the pixel electrode 11a included in the picture element of blue (B) are connected to the same source bus line 12a, and the pixel electrode 11b included in the picture element of green (G) and the pixel electrode 11b included in the picture element of white (W) are connected to the same source bus line 12b.

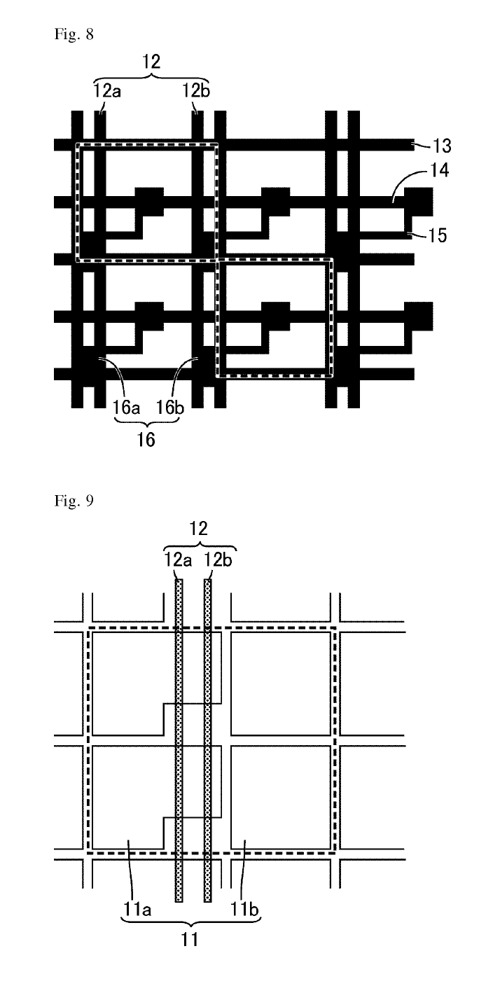

FIG. 8 is a schematic plan view illustrating light shielding regions of the display panel according to Embodiment 2. The source bus lines 12 are connected to the pixel electrodes through the TFTs 16, and the light shielding regions (black matrix) in a certain range for covering the TFTs 16 is formed in a region adjacent to the source bus lines 12. Further, a drain wiring line 15 extends from the TFT 16 toward the center, and a connection point between the line and the pixel electrode is formed with the extent of a certain range at the center of the picture element. Therefore, the light shielding region is formed in a shape according to the region in which the drain wiring line 15 is formed. Further, two source bus lines 12 extend in the picture elements of the larger areas, and thus the two light shielding regions are formed in each picture element along the regions in which the source bus lines 12 are disposed. Furthermore, the gate bus lines 13 extend in the row direction, and on the gaps between the pixel electrodes arranged in the column direction, these regions also form light shielding regions.

In Embodiment 2, the pixel electrodes with different areas are disposed in the single pixel, and thus the areas of the picture elements are different. As can be seen from FIG. 8, in the picture elements with different areas, the total areas of the light shielding regions are also different, and thus the actual aperture areas of the picture elements are adjusted to be substantially 1:1:1:1 as a whole.

Embodiment 2 is different from Embodiment 1 in that in the picture elements adjacent in the row direction, the extension directions of the drain wiring lines 15, which extend from the TFT 16 toward the centers of the picture elements, are the same. In other words, the drain wiring line 15 disposed for each picture element is formed in a similar shape in any of the picture elements which extend in the row direction and column direction.

### Embodiment 3

A display panel according to Embodiment 3 is the same as the display panel according to Embodiment 1 except that each pixel electrode is not rectangular and has a shape of a rectangle partially cut out.

FIG. 9 is a schematic plan view illustrating a wiring structure of the active matrix substrate of the display panel according to Embodiment 3. As shown in FIG. 9, pixel electrodes 11 are arranged in matrix, and source bus lines 12, through which image signals are sent to pixel electrodes 11, linearly extend in the column direction. A single pixel is a region (the portion surrounded by the dotted line of FIG. 9) in which four pixel electrodes 11 arranged in a squared shape are positioned, and two types (2n total) of large and small pixel electrodes 11 are disposed in the single pixel.

In Embodiment 3, each of the pixel electrodes 11a having the larger areas among the pixel electrodes 11 is partially cut out. Specifically, the lower side and the right side (the side close to the adjacent picture element in the same pixel) corner of each rectangular pixel electrode 11 is cut out, and thus the overlapping areas between the source bus lines 12 and the pixel electrodes are reduced. That is to say, the length of the overlapping portion between the source bus line 12 and the pixel electrode 11 is shorter than the length of the longest portion of the corresponding pixel electrode 11 in the same direction. The size of the cutout is about ⅓ times the size of the side along the column direction, and is about ½ times the size of the side along the row direction.

As described above, by partially cutting out the pixel electrode, the values of Csd1 and Csd2 are reduced. Hence, it is possible to effectively suppress deterioration in luminance and tinge shift in the case of the monochromatic or complementary color display and luminance unevenness caused in the manufacturing process, and thus it is possible to perform a high-quality display. Further, when the values of Csd1 and Csd2 are reduced, the capacitance of the source bus line is also reduced, and thus it is possible to suppress the current consumption of the circuit.

The space of the cutout of the pixel electrode 11 can be effectively used as, for example, a place for arrangement of the photo spacers, and thus the aperture ratio is not decreased. Further, when laminated spacers formed by laminating the color filters, the common electrode, and the like are used instead of the photo spacers, the spacers are efficient in that it is able to prevent leak between the pixel electrode and the common electrode.

Modified examples of Embodiment 3 include a configuration in which the upper side and right side corner of the rectangular pixel electrode 11 is cut out.

### Embodiment 4

A display panel according to Embodiment 4 is the same as the display panel according to Embodiment 2 except that each pixel electrode is not rectangular and has a shape of a rectangle partially cut out.

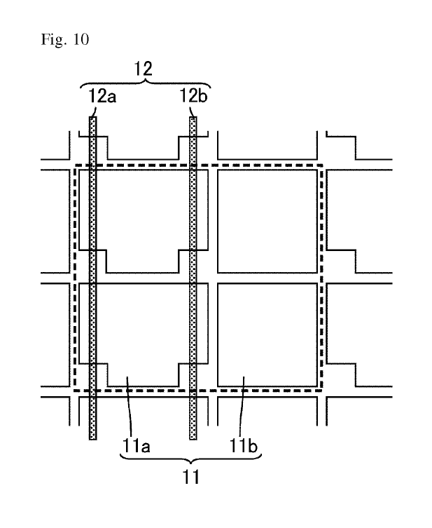

FIG. 10 is a schematic plan view illustrating a wiring structure of the active matrix substrate of the display panel according to Embodiment 4. As shown in FIG. 10, pixel electrodes 11 are arranged in matrix, and source bus lines 12, through which image signals are sent to pixel electrodes 11, linearly extend in the column direction. A single pixel is a region (the portion surrounded by the dotted line of FIG. 10) in which four pixel electrodes 11 arranged in a squared shape are positioned, and two types (2n total) of large and small pixel electrodes 11 are disposed in the single pixel.

In Embodiment 4, each of the pixel electrodes 11a having the larger areas among the pixel electrodes 11 is partially cut out. Specifically, both corners of the lower side of each rectangular pixel electrode 11 are cut out, and thus the overlapping areas between the source bus lines 12 and the pixel electrodes are reduced. That is to say, the length of the overlapping portion between the source bus line 12 and the pixel electrode 11 is shorter than the length of the longest portion of the corresponding pixel electrode 11 in the same direction. The size of each cutout is about ⅕ times the size of the side along the column direction, and is about ⅓ times the size of the side along the row direction.

As described above, by partially cutting out the pixel electrode, the values of Csd1 and Csd2 are reduced. Hence, it is possible to effectively suppress deterioration in luminance and tinge shift in the case of the monochromatic or complementary color display and luminance unevenness caused in the manufacturing process, and thus it is possible to perform a high-quality display. Further, when the values of Csd1 and Csd2 are reduced, the capacitance of the source bus line 12 is also reduced, and thus it is possible to suppress the current consumption of the circuit.

The space of each cutout of the pixel electrode can be effectively used as, for example, a place for arrangement of the photo spacers, and thus the aperture ratio is not decreased. Further, when laminated spacers formed by laminating the color filters, the common electrode, and the like are used instead of the photo spacers, the spacers are efficient in that it is able to prevent a leak between the pixel electrode and the common electrode.

Modified examples of Embodiment 4 include: (1) a configuration in which both corners of the upper side of the rectangular pixel electrode are cut out; (2) a configuration in which only the single corner of the lower side of the rectangular pixel electrode is cut out; and (3) a configuration in which only the single corner of the upper side of the rectangular pixel electrode is cut out.

### Evaluation Test 1

Hereinafter, examples (Examples 1 to 4), in which the display panels according to Embodiment 1 are fabricated in practice, and examples (Reference Examples 1 to 5), in which display panels for comparison with that of the present invention are fabricated, will be shown, and results of evaluation tests, in which characteristics of Example 1 and Reference Examples 1 to 5 are compared, will be shown. In all the following Examples 1 to 4 and Reference Examples 1 to 5, the unit pixel size is 10-WXGA (170 μm×170 μm). Thus, it is assumed that the display panel is not used in large-size displays such as a television but used in small-size displays such as a mobile device. Further, in the following Examples 1 to 4 and Reference Examples 1 to 5, a CPA mode is employed as a liquid crystal alignment mode, and thus a single rivet or plural rivets are provided in each picture element. Furthermore, in the evaluation test, the dot reversal driving in which a polarity is set to be reversed for each pixel is employed.

In the following Table 1, the aperture ratios, the transmissivity ratios, the misalignment coefficients (ΔΔVdr), and the tinge shifts (Csd1/Cpix) of Example 1 and Reference Examples 1 to 5 are collected.

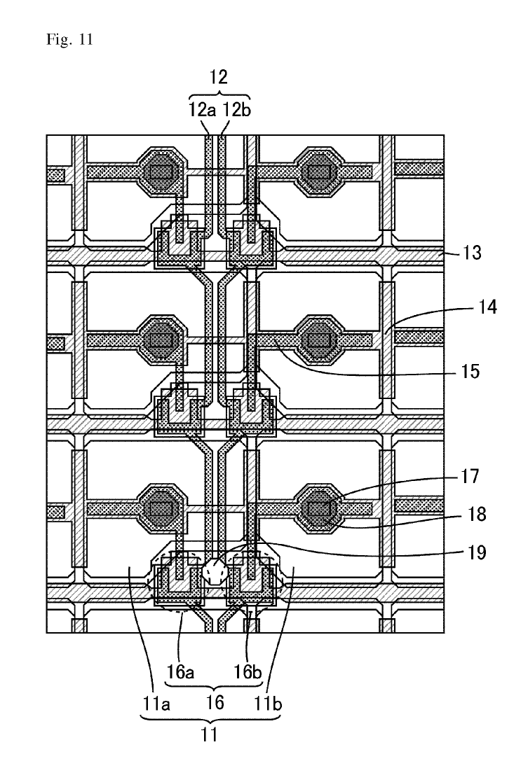

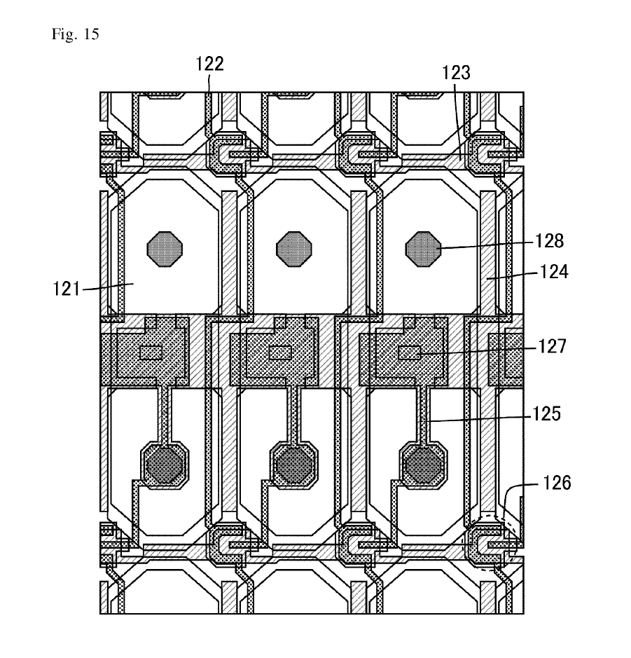

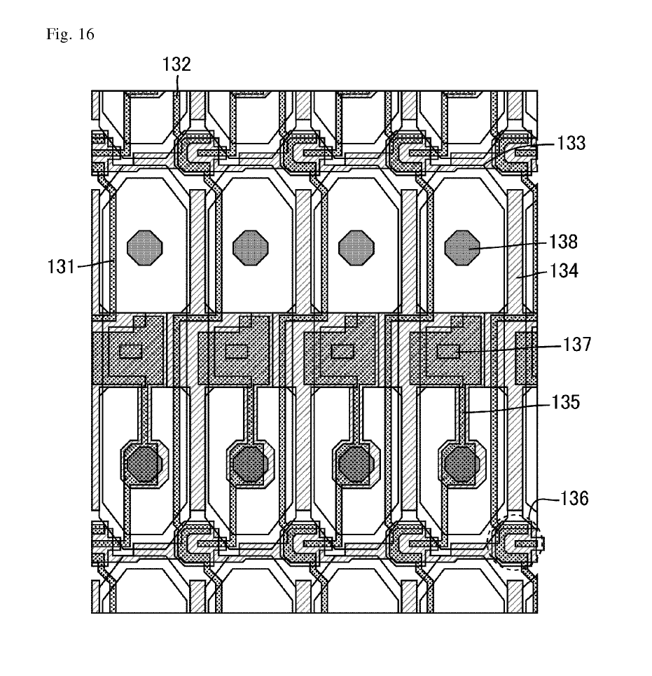

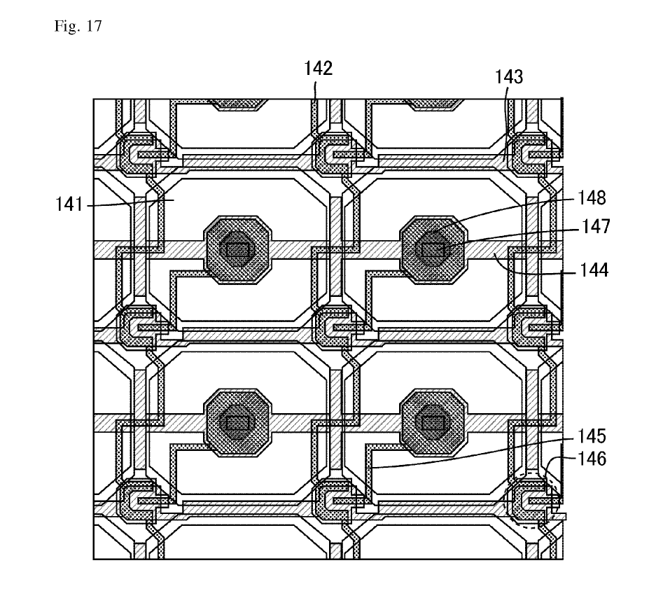

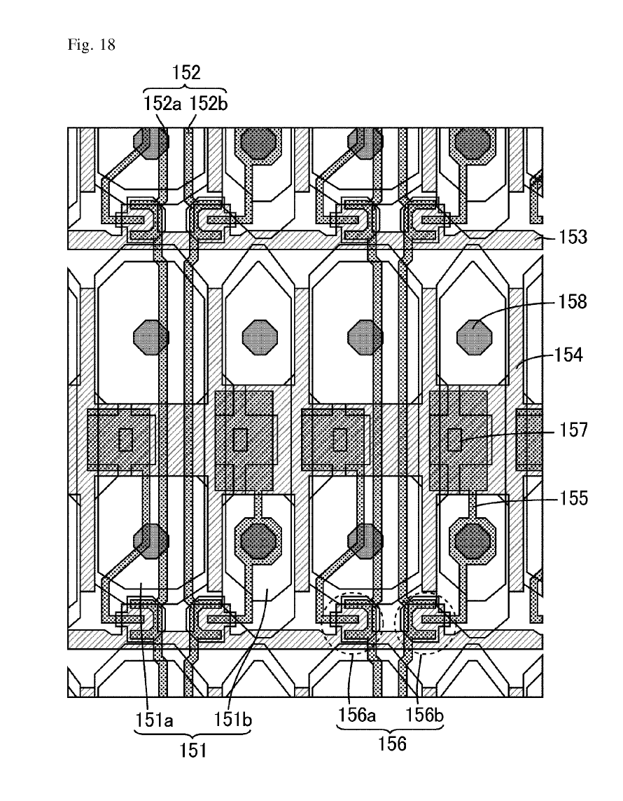

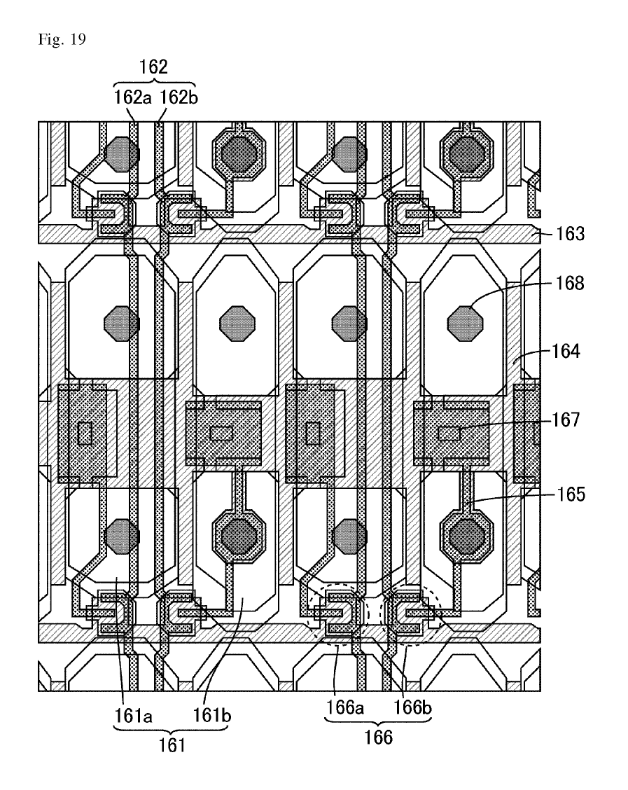

TABLE 1

| | | Reference | Reference | Reference | Reference | Reference |
|---|---|---|---|---|---|---|
| | Example 1 | Example 1 | Example 2 | Example 3 | Example 4 | Example 5 |
| Corresponding | FIG. 11 | FIG. 15 | FIG. 16 | FIG. 17 | FIG. 18 | FIG. 19 |
| fiture | | | | | | |
| Color | RGBW | RGB | RGBW | RGBW | RGBG | RGBW |
| arrangement | | | | | | |
| Area ratio | 1:1:1:1 | 1:1:1 | 1:1:1:1 | 1:1:1:1 | 1:0.5:1:0.5 | 1:1:1:1 |
| Arrangement | Squared | Stripe | Stripe | Squared | Stripe | Stripe |
| Aperture ratio | 1.02 | 1 | 0.58 | 0.98 | 0.78 | 0.81 |
| Transmissivity | 1.59 | 1 | 0.9 | 1.52 | 0.79 | 1.26 |
| ratio | | | | | | |
| Misalignment | 0.1 | 1 | 1.3 | 0.65 | 0.18 | 0.2 |
| coefficient | | | | | | |
| Tinge shift | 0.8 | 1 | 1.4 | 0.5 | 1.6 | 2.3 |

Hereinafter, differences of configurations between Examples 1 to 4 and Reference Examples 1 to 5 will be described in detail.

### Example 1

FIG. 11 is a schematic plan view illustrating an example of a wiring structure of an active matrix substrate of a display panel according to Example 1. As shown in FIG. 11, in the display panel according to Example 1, the pixel electrodes 11 are arranged in matrix, and a region, in which two pixel electrodes 11 are arranged in each of the row direction and the column direction, constitutes a single pixel. In Example 1, the respective color filters with different colors are positioned to overlap with the respective pixel electrodes 11. The ratio of the actual aperture areas in each picture element is red (R):green (G):blue (B):white (W)=1:1:1:1.

Further, the two source bus lines 12, through which image signals are supplied to the pixel electrodes 11, are disposed to overlap with the pixel electrode 11a having the larger area between the two pixel electrodes 11 which are arranged in the row direction. One of the two source bus lines 12 is connected to one of the pixel electrodes 11 arranged in the row direction through the TFT 16, and the other one is connected to the other one of the pixel electrodes 11 arranged in the row direction through the TFT 16. In Example 1, the areas of the pixel electrodes 11a arranged in the left side column in the pixel are larger than the areas of the pixel electrodes 11b arranged in the right side column, and both of the two source bus lines 12 overlap with the pixel electrodes 11a arranged in the left side column. In addition, the left side source bus line 12a is connected to the pixel electrodes in the left side column through the TFTs 16a, and the right side source bus line 12b is connected to the pixel electrode 11b in the right side column through the TFTs 16b. All the source bus lines 12a and 12b are formed in a substantially linear shape without having any large curve.

Further, the gate bus lines 13, through which gate signals are supplied, extend in the row direction so as to cover the gaps between the pixel electrodes 11 arranged in the column direction, and each of the lines is connected to TFTs 16. Furthermore, in a similar manner to the gate bus lines 13, the auxiliary capacitance (CS) bus lines 14 extend in the row direction, and each of the lines is disposed to overlap the pixel electrodes 11 arranged in the row direction.

Each TFT 16 is positioned not to overlap with the pixel electrode 11. In order to secure the places for arrangement of TFTs 16, each pixel electrode 11 is partially cut out. In Example 1, regarding the pixel electrodes 11a in the left column, the lower right portion of each pixel electrode 11a is cut out, and regarding the pixel electrodes 11b in the right column, the lower left portion of each pixel electrode 11b is cut out. The sizes of the cutouts are different between the pixel electrodes 11a in the left column and the pixel electrode 11b in the right column.

The TFT 16 is a three-terminal field-effect transistor, and has a semiconductor layer and three electrodes of the gate electrode, the source electrode, and the drain electrode. The gate electrode is connected to the gate bus line 13, the source electrode is connected to the source bus line 12, and the drain electrode is connected to the pixel electrode 11 through the drain wiring line 15. At the timing of supplying the gate signal to the gate electrode, the image signal is transferred in order of the source electrode, the semiconductor layer, and the drain electrode, and is supplied to the pixel electrode 11.

The drain wiring line 15 is provided to extend from the drain electrode of the TFT 16 toward the center of the pixel electrode 11. In addition, the line has a region, which is expanded in a certain range, at and around the center of the pixel electrode 11, and is connected to the pixel electrode 11 through the contact hole 17 provided in the insulation film within the corresponding region.

Further, the CS bus line 14 extends in the place, in which the line overlaps with the drain wiring line 15, with the insulation film interposed therebetween, and a certain amount of the auxiliary capacitance is formed between the drain wiring line 15 and the CS bus line 14. The CS bus line 14 has a shape along the drain wiring line 15, and has a region, which is expanded in a certain range, at and around the center of the pixel electrode 11.

Furthermore, each CS bus line 14 further extends to the vicinity of the position of the gap between the pixel electrodes 11 arranged in the row direction, and extends in the column direction so as to cover the gap between the pixel electrodes 11. Thereby, it is possible to prevent light from passing through the gaps between the pixel electrodes 11, and thus it is possible to effectively improve the contrast ratio. The drain wiring line 15, which is connected to the right side pixel electrode (the pixel electrode having the smaller area) 11b of the pixel electrodes 11 arranged in the row direction, has a path which extends along the gap between the pixel electrodes 11 arranged in the row direction and is extracted up to the center of the pixel electrode 11. Thereby, the drain wiring line 15 can be extracted to the pixel electrode 11 without decreasing the aperture ratio.

Further, each photo spacer 19 is disposed in the region in which the pixel electrode is cut out. Thereby, the aperture ratio does not have to be reduced.

The rivet 18 is provided in the center region of each picture element, and liquid crystal molecules close thereto are radially aligned toward the rivet 18. Therefore, it is possible to form plural domains each of which has different alignment of the liquid crystal molecules in the single pixel, and thus the viewing angle is enhanced.

### Example 2

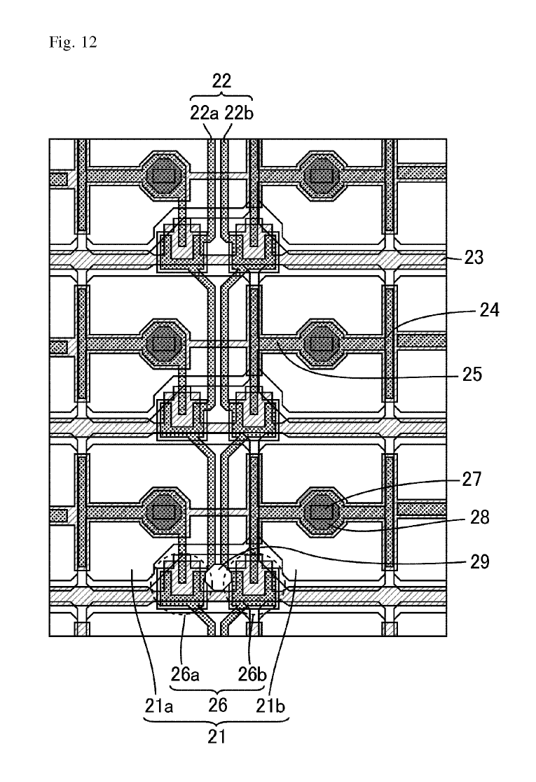

FIG. 12 is a schematic plan view illustrating an example of a wiring structure of an active matrix substrate of a display panel according to Example 2. As shown in FIG. 12, in the display panel according to Example 2, the pixel electrodes 21 are arranged in matrix, and a region, in which two pixel electrodes 21 are arranged in each of the row direction and the column direction, constitutes a single pixel. In Example 2, the respective color filters with different colors are positioned to overlap with the respective pixel electrodes 21. The ratio of the actual aperture areas in each picture element is red (R):green (G):blue (B):white (W)=1:1:1:1.

Further, the two source bus lines 22, through which image signals are supplied to the pixel electrodes 21, are disposed to overlap with the pixel electrode 21a having the larger area between the two pixel electrodes 21 which are arranged in the row direction. One of the two source bus lines 22 is connected to one of the pixel electrodes 21 arranged in the row direction through the TFT 26, and the other one is connected to the other one of the pixel electrodes 21 arranged in the row direction through the TFT 26. In Example 2, the areas of the pixel electrodes 21a arranged in the left side column in the pixel are larger than the areas of the pixel electrodes 21b arranged in the right side column, and both of the two source bus lines 22 overlap with the pixel electrodes 21a arranged in the left side column. In addition, the left side source bus line 22a is connected to the pixel electrodes in the left side column through the TFTs 26a, and the right side source bus line 22b is connected to the pixel electrode 21b in the right side column through the TFTs 26b. All the source bus lines 22a and 22b are formed in a substantially linear shape without having any large curve.

Further, the gate bus lines 23, through which gate signals are supplied, extend in the row direction so as to cover the gaps between the pixel electrodes 21 arranged in the column direction, and each of the lines is connected to TFTs 26. Furthermore, in a similar manner to the gate bus lines 23, the auxiliary capacitance (CS) bus lines 24 extend in the row direction, and each of the lines is disposed to overlap the pixel electrodes 21 arranged in the row direction.

Each TFT 26 is positioned not to overlap with the pixel electrode 21. In order to secure the places for arrangement of TFTs 26, each pixel electrode 21 is partially cut out. In Example 2, regarding the pixel electrodes 21a in the left column, the lower right portion of each pixel electrode 21a is cut out, and regarding the pixel electrodes 21b in the right column, the lower left portion of each pixel electrode 21b is cut out. The sizes of the cutouts are different between the pixel electrodes 21a in the left column and the pixel electrode 21b in the right column.

The TFT 26 is a three-terminal field-effect transistor, and has a semiconductor layer and three electrodes of the gate electrode, the source electrode, and the drain electrode. The gate electrode is connected to the gate bus line 23, the source electrode is connected to the source bus line 22, and the drain electrode is connected to the pixel electrode 21 through the drain wiring line 25. At the timing of supplying the gate signal to the gate electrode, the image signal is transferred in order of the source electrode, the semiconductor layer, and the drain electrode, and is supplied to the pixel electrode 21.

The drain wiring line 25 is provided to extend from the drain electrode of the TFT 26 toward the center of the pixel electrode 21. In addition, the line has a region, which is expanded in a certain range, at and around the center of the pixel electrode 21, and is connected to the pixel electrode 21 through the contact hole 27 provided in the insulation film within the corresponding region.

Further, the CS bus line 24 extends in the place, in which the line overlaps with the drain wiring line 25, with the insulation film interposed therebetween, and a certain amount of the auxiliary capacitance is formed between the drain wiring line 25 and the CS bus line 24. The CS bus line 24 has a shape along the drain wiring line 25, and has a region, which is expanded in a certain range, at and around the center of the pixel electrode 21.

Furthermore, each CS bus line 24 further extends to the vicinity of the position of the gap between the pixel electrodes 21 arranged in the row direction, and extends in the column direction so as to cover the gap between the pixel electrodes 21. Thereby, it is possible to prevent light from passing through the gaps between the pixel electrodes 21, and thus it is possible to effectively improve the contrast ratio. The drain wiring line 25, which is connected to the right side pixel electrode (the pixel electrode having the smaller area) 21b of the pixel electrodes 21 arranged in the row direction, has a path which extends along the gap between the pixel electrodes 21 arranged in the row direction and is extracted up to the center of the pixel electrode 21. Thereby, the drain wiring line 25 can be extracted to the pixel electrode 21 without decreasing the aperture ratio.

Further, each photo spacer 29 is disposed in the region in which the pixel electrode is cut out. Thereby, the aperture ratio does not have to be reduced.

The rivet 28 is provided in the center region of each picture element, and liquid crystal molecules close thereto are radially aligned toward the rivet 28. Therefore, it is possible to form plural domains each of which has different alignment of the liquid crystal molecules in the single pixel, and thus the viewing angle is enhanced.

Further, as shown in FIG. 12, in the display panel according to Example 2, by extending the drain wiring lines 25 to the positions of the gaps between the pixel electrodes 21 arranged in the row direction, the overlapping areas between the CS bus lines 24 and the pixel electrodes are further increased. Therefore, it is possible to secure more auxiliary capacitance in the region, and it is possible to increases the aperture ratio by decreasing the areas of the CS bus line 24 and drain wiring line 25 in each aperture region.

### Example 3

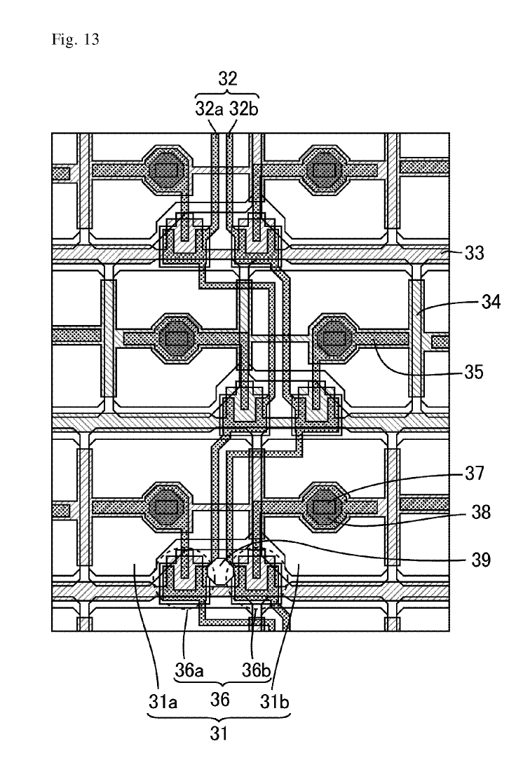

FIG. 13 is a schematic plan view illustrating an example of a wiring structure of an active matrix substrate of a display panel according to Example 3. As shown in FIG. 13, in the display panel according to Example 3, the pixel electrodes 31 are arranged in matrix, and a region, in which two pixel electrodes 31 are arranged in each of the row direction and the column direction, constitutes a single pixel. In Example 3, the respective color filters with different colors are positioned to overlap with the respective pixel electrodes 31. The ratio of the actual aperture areas in each picture element is red (R):green (G):blue (B):white (W)=1:1:1:1.

In Example 3, the two source bus lines 32, through which image signals are supplied to the pixel electrodes 31, are disposed to overlap with the pixel electrode 31a having the larger area between the two pixel electrodes 31 which are arranged in the row direction. As shown in FIG. 13, the display panel according to Example 3 is the same as the panels according to Example 1 and Example 2 in that the areas of the pixel electrode 31 arranged in the row direction are different from each other. However, the arrangement positions of the pixel electrode having the larger area 31a and the pixel electrode having the smaller area 31b are changed for each row. That is, in the single pixel, the two pixel electrodes 31a having the larger areas and the two pixel electrodes 31b having the smaller areas are disposed in a checkered pattern shape. Further, each of the source bus lines 32a and 32b is formed in a staggered shape so as to overlap with the pixel electrodes having larger areas 31a.

In Example 3, the gate bus lines 33, through which gate signals are supplied, extend in the row direction so as to cover the gaps between the pixel electrodes 31 arranged in the column direction, and each of the lines is connected to TFTs 36a and 36b. Further, in a similar manner to the gate bus lines 33, the auxiliary capacitance (CS) bus lines 34 extend in the row direction, and each of the lines is disposed to overlap the pixel electrodes 31 arranged in the row direction.

Each TFT 36 is positioned not to overlap with the pixel electrode 31. In order to secure the places for arrangement of TFTs 36, each pixel electrode 31 is partially cut out. In Example 3, regarding the pixel electrodes 31a in the left column, the lower right portion of each pixel electrode 31a is cut out, and regarding the pixel electrodes 31b in the right column, the lower left portion of each pixel electrode 31b is cut out. The sizes of the cutouts are different between the pixel electrodes 31a in the left column and the pixel electrode 31b in the right column.

The TFT 36 is a three-terminal field-effect transistor, and has a semiconductor layer and three electrodes of the gate electrode, the source electrode, and the drain electrode. The gate electrode is connected to the gate bus line 33, the source electrode is connected to the source bus line 32, and the drain electrode is connected to the pixel electrode 31 through the drain wiring line 35. At the timing of supplying the gate signal to the gate electrode, the image signal is transferred in order of the source electrode, the semiconductor layer, and the drain electrode, and is supplied to the pixel electrode 31.

The drain wiring line 35 is provided to extend from the drain electrode of the TFT 36 toward the center of the pixel electrode 31. In addition, the line has a region, which is expanded in a certain range, at and around the center of the pixel electrode 31, and is connected to the pixel electrode 31 through the contact hole 37 provided in the insulation film within the corresponding region.

Further, the CS bus line 34 extends in the place, in which the line overlaps with the drain wiring line 35, with the insulation film interposed therebetween, and a certain amount of the auxiliary capacitance is formed between the drain wiring line 35 and the CS bus line 34. The CS bus line 34 has a shape along the drain wiring line 35, and has a region, which is expanded in a certain range, at and around the center of the pixel electrode 31.

Furthermore, each CS bus line 34 further extends to the vicinity of the position of the gap between the pixel electrodes 31 arranged in the row direction, and extends in the column direction so as to cover the gap between the pixel electrodes 31. Thereby, it is possible to prevent light from passing through the gaps between the pixel electrodes 31, and thus it is possible to effectively improve the contrast ratio. The drain wiring line 35, which is connected to the right side pixel electrode (the pixel electrode having the smaller area) 31b of the pixel electrodes 31 arranged in the row direction, has a path which extends along the gap between the pixel electrodes 31 arranged in the row direction and is extracted up to the center of the pixel electrode 31. Thereby, the drain wiring line 35 can be extracted to the pixel electrode 31 without decreasing the aperture ratio.

Further, each photo spacer 39 is disposed in the region in which the pixel electrode is cut out. Thereby, the aperture ratio does not have to be reduced.

The rivet 38 is provided in the center region of each picture element, and liquid crystal molecules close thereto are radially aligned toward the rivet 38. Therefore, it is possible to form plural domains each of which has different alignments of the liquid crystal molecules in the single pixel, and thus the viewing angle is enhanced.

As described above, the display panel according to Example 3 is different from the panels according to Example 1 and Example 2 in arrangement of pixel electrodes having different areas. However, the display panel according to Example 3 is the same as the panels according to Example 1 and Example 2 in that all the two source bus lines are disposed to overlap with the pixel electrodes having larger areas. Factors, which have an effect on the misalignment coefficient (ΔΔVdr) and the chromaticity shift such as the total of overlapping areas between the pixel electrodes and the source bus lines in the single pixel, satisfy the requirements of Embodiment 1.

### Example 4

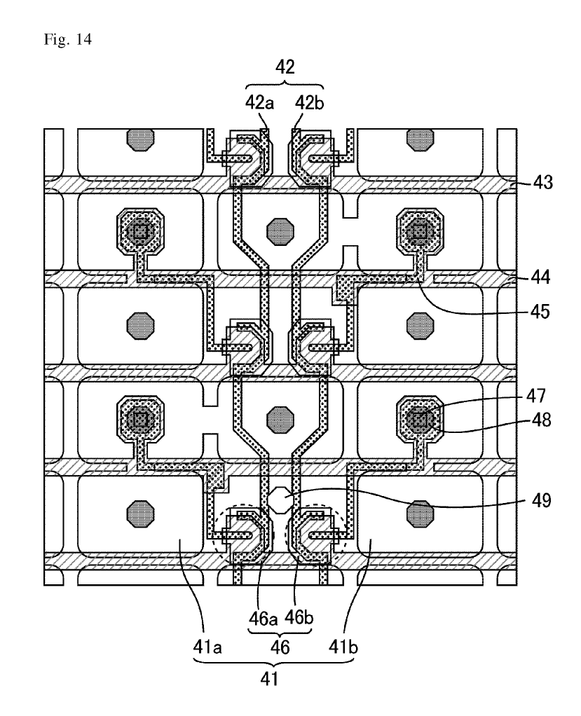

FIG. 14 is a schematic plan view illustrating an example of a wiring structure of an active matrix substrate of a display panel according to Example 4. As shown in FIG. 14, in the display panel according to Example 4, each of the pixel electrodes 41 is divided into plural units, and the area of the pixel electrode 41 is determined by addition based on the numbers of units (0.5 pieces) to each other. The pixel electrodes 41 are arranged in matrix, and a region, in which four pixel electrodes are arranged in each of the row direction and the column direction, constitutes a single pixel. The ratio of the actual aperture areas in each picture element is red (R):green (G):blue (B):white (W)=1:1.5:1:1.5.

As shown in FIG. 14, in the display panel according to Example 4, similarly to the display panel according to Example 3, the areas of the pixel electrodes 41 arranged in the row direction are different from each other. However, the arrangement positions of the pixel electrode 41a having the larger area and the pixel electrode 41b having the smaller area are changed for each row. That is, in the single pixel, the two pixel electrodes 41a having the larger areas and the two pixel electrodes 41b having the smaller areas are disposed in a checkered pattern shape. Further, each of the source bus lines 42a and 42b is formed in a staggered shape so as to overlap with the pixel electrodes 41a having larger areas. In such a case, factors, which have an effect on the misalignment coefficient (ΔΔVdr) and the chromaticity shift such as the total of overlapping areas between the pixel electrodes 41 and the source bus lines 42 in the single pixel, satisfy the requirements of Embodiment 1.

In Example 4, the gate bus lines 43, through which gate signals are supplied, extend in the row direction so as to cover the gaps between the pixel electrodes 41 arranged in the column direction, and each of the lines is connected to TFTs 46a and 46b.

The gate electrode of the TFT 46 is connected to the gate bus line 43, the source electrode is connected to the source bus line 42, and the drain electrode is connected to the pixel electrode 41 through the drain wiring line 45. At the timing of supplying the gate signal to the gate electrode, the image signal is transferred in order of the source electrode, the semiconductor layer, and the drain electrode, and is supplied to the pixel electrode 41. Each TFT 46 is disposed in the region in which the pixel electrode 41 is cut out.

The drain wiring line 45 is provided to extend from the drain electrode of the TFT 46 toward the center of the pixel electrode 41. In addition, the line has a region, which is expanded in a certain range, at and around the center of the pixel electrode 41, and is connected to the pixel electrode 41 through the contact hole 47 provided in the insulation film within the corresponding region.

The auxiliary capacitance (CS) bus line 44 extends in the place, in which the line overlaps with the extension region of the drain wiring line 45, with the insulation film interposed therebetween, and a certain amount of the auxiliary capacitance is formed between the drain wiring line 45 and the CS bus line 44. The CS bus line 44 extends in the row direction, and a part thereof extends so as to overlap with the extension region of the drain wiring line 45.

In Example 4, in a similar manner to Example 3, the two source bus lines 42, through which image signals are supplied, are disposed to overlap with the pixel electrode 41a having the larger area between the two pixel electrodes 41 which are arranged in the row direction. One of the two source bus lines 42 is connected to one of the pixel electrodes 41 arranged in the row direction through the TFT 46, and the other one is connected to the other one of the pixel electrodes 41 arranged in the row direction through the TFT 46.

Further, each photo spacer 49 is disposed in the region in which the pixel electrode is cut out. Thereby, the aperture ratio does not have to be reduced.

The rivet 48 is provided in the center region of each picture element, and liquid crystal molecules close thereto are radially aligned toward the rivet 48. Therefore, it is possible to form plural domains each of which has different alignment of the liquid crystal molecules in the single pixel, and thus the viewing angle is enhanced.

As described above, the display panel according to Example 4 is the same as the panel according to Example 3 in arrangement of pixel electrodes. Factors, which have an effect on the misalignment coefficient (ΔΔVdr) and the chromaticity shift such as the total of overlapping areas between the pixel electrodes and the source bus lines in the single pixel, satisfy the requirements of Embodiment 1.

### Reference Example 1

A display panel according to Reference Example 1 is an example of a conventional liquid crystal display panel in which color filters of three colors of red (R), green (G), and blue (B) are arranged in a stripe shape. The ratio of the actual aperture areas in each picture element is red (R):green (G):blue (B)=1:1:1.

FIG. 15 is a schematic plan view illustrating an example of a wiring structure of an active matrix substrate of a display panel according to Reference Example 1. As shown in FIG. 15, in the display panel according to Reference Example 1, the pixel electrodes 121 are arranged in matrix, and a region, in which the three pixel electrodes 121 are arranged in the row direction, constitutes a single pixel.

In Reference Example 1, the gate bus lines 123, through which gate signals are supplied, extend in the row direction so as to cover the gaps between the pixel electrodes 121 arranged in the column direction, and each of the lines is connected to TFTs 126.

The gate electrode of the TFT 126 is connected to the gate bus line 123, the source electrode is connected to the source bus line 122, and the drain electrode is connected to the pixel electrode 121 through the drain wiring line 125. At the timing of supplying the gate signal to the gate electrode, the image signal is transferred in order of the source electrode, the semiconductor layer, and the drain electrode, and is supplied to the pixel electrode. Each TFT 126 is disposed in the region in which the pixel electrode 121 is cut out.

The drain wiring line 125 is provided to extend from the drain electrode of the TFT 126 toward the center of the pixel electrode 121. In addition, the line has a region, which is expanded in a certain range, at and around the center of the pixel electrode 121, and is connected to the pixel electrode 121 through the contact hole 127 provided in the insulation film within the corresponding region.

The auxiliary capacitance (CS) bus line 124 extends in the place, in which the line overlaps with the extension region of the drain wiring line 125, with the insulation film interposed therebetween, and a certain amount of the auxiliary capacitance is formed between the drain wiring line 125 and the CS bus line 124. The CS bus line 124 extends in the row direction so as to have a substantially linear shape having a uniform width. In addition, a part of each CS bus line 124 further extends to the vicinity of the position of the gap between the pixel electrodes 121 arranged in the row direction, and extends in the column direction so as to cover the gap between the pixel electrodes 121.

In Reference Example 1, each source bus line 122, through which the image signal is supplied, is formed to not have a linear shape but a staggered shape in which the line is partially curved so as to alternately overlap with one pixel electrode 121 and the other pixel electrode 121 adjacent to each other in the row direction. With such a configuration, the overlapping areas between the source bus lines 122 and the pixel electrodes 121 are not so greatly changed between the adjacent picture elements even if there is misalignment between the source bus lines 122 and the pixel electrodes 121. As a result, it is possible to reduce display unevenness.

However, the configuration of Reference Example 1 does not include a high luminance color (for example, yellow (Y) or white (W)), and thus it is difficult to secure a sufficient transmissivity compared with the case of Example 1. Further, the size of the pixel electrode 121 is equivalent in each picture element, and the two source bus lines 122 are not integrated onto one pixel electrode. Hence, compared with the configuration of Example 1, the misalignment coefficient (ΔΔVdr) drastically increases, and thus display unevenness tends to occur.

### Reference Example 2

A display panel according to Reference Example 2 is an example of a conventional liquid crystal display panel in which color filters of four colors of red (R), green (G), blue (B), and white (W) are arranged in a stripe shape. The ratio of the actual aperture areas in each picture element is red (R):green (G):blue (B):white (W)=1:1:1:1.

FIG. 16 is a schematic plan view illustrating an example of a wiring structure of an active matrix substrate of a display panel according to Reference Example 2. As shown in FIG. 16, in the display panel according to Reference Example 2, the pixel electrodes 131 are arranged in matrix, and a region, in which the three pixel electrodes 131 are arranged in the row direction, constitutes a single pixel.

In Reference Example 2, the gate bus lines 133, through which gate signals are supplied, extend in the row direction so as to cover the gaps between the pixel electrodes 131 arranged in the column direction, and each of the lines is connected to TFTs 136.

The gate electrode of the TFT 136 is connected to the gate bus line 133, the source electrode is connected to the source bus line 132, and the drain electrode is connected to the pixel electrode 131 through the drain wiring line 135. At the timing of supplying the gate signal to the gate electrode, the image signal is transferred in order of the source electrode, the semiconductor layer, and the drain electrode, and is supplied to the pixel electrode 131. Each TFT 136 is disposed in the region in which the pixel electrode 131 is cut out.

The drain wiring line 135 is provided to extend from the drain electrode of the TFT 136 toward the center of the pixel electrode. In addition, the line has a region, which is expanded in a certain range, at and around the center of the pixel electrode 131, and is connected to the pixel electrode 131 through the contact hole 137 provided in the insulation film within the corresponding region.

The auxiliary capacitance (CS) bus line 134 extends in the place, in which the line overlaps with the extension region of the drain wiring line 135, with the insulation film interposed therebetween, and a certain amount of the auxiliary capacitance is formed between the drain wiring line 135 and the CS bus line 134. The CS bus line 134 extends in the row direction so as to have a substantially linear shape having a uniform width. In addition, a part of each CS bus line 134 further extends to the vicinity of the position of the gap between the pixel electrodes 131 arranged in the row direction, and extends in the column direction so as to cover the gap between the pixel electrodes 131.

In Reference Example 2, each source bus line 132, through which the image signal is supplied, is formed to not have a linear shape but a staggered shape in which the line is partially curved so as to alternately overlap with one pixel electrode 131 and the other pixel electrode 131 adjacent to each other in the row direction. With such a configuration, the overlapping areas between the source bus lines 132 and the pixel electrodes 131 are not so greatly changed between the adjacent picture elements even if there is misalignment between the source bus lines 132 and the pixel electrodes. As a result, it is possible to reduce display unevenness.

However, in the case of the configuration of Reference Example 2, in spite of decreasing the total area of the pixel electrodes 131 of the single pixel by using four color picture elements instead of three picture elements, the overlapping area between the pixel electrodes 131 of the single pixel and the source bus lines 132 drastically increases. Hence, deviation of the monochromatic luminance increases, and the tinge shift tends to occur. Further, the size of the pixel electrode 131 is equivalent in each picture element, and the two source bus lines 132 are not integrated onto one pixel electrode 131. Hence, compared with the configuration of Example 1, the misalignment coefficient (ΔΔVdr) drastically increases, and thus display unevenness tends to occur. Furthermore, as a color filter of high luminance white (W) is included, the transmissivity is improved compared with Reference Example 1. However, the areas of the CS bus line 134 and the drain wiring line 135 are large compared with Example 1, and thus it is difficult to obtain a sufficient transmissivity. In addition, as the total area of the pixel electrodes 131 of the single pixel decreases, the aperture ratio decreases.

### Reference Example 3

A display panel according to Reference Example 3 is an example of a conventional liquid crystal display panel in which color filters of four colors of red (R), green (G), blue (B), and white (W) are arranged in a squared shape. The ratio of the actual aperture areas in each picture element is red (R):green (G):blue (B):white (W)=1:1:1:1.

FIG. 17 is a schematic plan view illustrating an example of a wiring structure of an active matrix substrate of a display panel according to Reference Example 3. As shown in FIG. 17, in the display panel according to Reference Example 3, the pixel electrodes 141 are arranged in matrix, and a region, in which the two pixel electrodes 141 are arranged in each of the row direction and the column direction, constitutes a single pixel.

In Reference Example 3, the gate bus lines 143, through which gate signals are supplied, extend in the row direction so as to cover the gaps between the pixel electrodes 141 arranged in the column direction, and each of the lines is connected to TFTs 146.

The gate electrode of the TFT 146 is connected to the gate bus line 143, the source electrode is connected to the source bus line 142, and the drain electrode is connected to the pixel electrode 141 through the drain wiring line 145. At the timing of supplying the gate signal to the gate electrode, the image signal is transferred in order of the source electrode, the semiconductor layer, and the drain electrode, and is supplied to the pixel electrode 141. Each TFT 146 is disposed in the region in which the pixel electrode 141 is cut out.

The drain wiring line 145 is provided to extend from the drain electrode of the TFT 146 toward the center of the pixel electrode 141. In addition, the line has a region, which is expanded in a certain range, at and around the center of the pixel electrode 141, and is connected to the pixel electrode 141 through the contact hole 147 provided in the insulation film within the corresponding region.

The auxiliary capacitance (CS) bus line 143 extends in the place, in which the line overlaps with the extension region of the drain wiring line 145, with the insulation film interposed therebetween, and a certain amount of the auxiliary capacitance is formed between the drain wiring line 145 and the CS bus line 143. The CS bus line 143 extends in the row direction so as to have a substantially linear shape having a uniform width. In addition, a part of each CS bus line 143 extends to the vicinity of the position of the gap between the pixel electrodes 141 arranged in the row direction, and extends in the column direction so as to cover the gap between the pixel electrodes 141.

In Reference Example 3, each source bus line 142, through which the image signal is supplied, is formed to not have a linear shape but a staggered shape in which the line is partially curved so as to alternately overlap with one pixel electrode 141 and the other pixel electrode 141 adjacent to each other in the row direction. With such a configuration, the overlapping areas between the source bus lines 142 and the pixel electrodes 141 are not so greatly changed between the adjacent picture elements even if there is misalignment between the source bus lines 142 and the pixel electrodes 141. As a result, it is possible to reduce display unevenness.

However, in the case of the configuration of Reference Example 3, the areas of the four pixel electrodes 141 formed in a squared shape are the same, and the source bus lines are not integrated onto one pixel electrode 141. Hence, compared with Example 1, the misalignment coefficient (ΔΔVdr) drastically increases, and thus display unevenness tends to occur.

Further, in both configurations of Example 1 and Reference Example 3, the squared array is adopted, but the members disposed on non-transparent portions such as the TFTs and the photo spacers are more easily integrated when the source bus lines overlap with one of the pixel electrodes in a similar manner to Example 1. Hence, the photo spacers and the CS bus lines 144 are efficiently arranged, and thus it is easy to secure a high aperture ratio.

### Reference Example 4

A display panel according to Reference Example 4 is an example of a conventional liquid crystal display panel in which color filters of three colors of red (R), green (G), blue (B), and green (G) are arranged in a stripe shape in four columns. The ratio of the actual aperture areas in each picture element is red (R):green (G):blue (B):green (G)=1:0.5:1:0.5.

FIG. 18 is a schematic plan view illustrating an example of a wiring structure of an active matrix substrate of a display panel according to Reference Example 4. As shown in FIG. 18, in the display panel according to Reference Example 4, the pixel electrodes 151 are arranged in matrix, and a region, in which the four pixel electrodes 151 are arranged in the row direction, constitutes a single pixel.

In Reference Example 4, the gate bus lines 153, through which gate signals are supplied, extend in the row direction so as to cover the gaps between the pixel electrodes 151 arranged in the column direction, and each of the lines is connected to TFTs 156.

The gate electrode of the TFT 156 is connected to the gate bus line 153, the source electrode is connected to the source bus line 152, and the drain electrode is connected to the pixel electrode 151 through the drain wiring line 155. At the timing of supplying the gate signal to the gate electrode, the image signal is transferred in order of the source electrode, the semiconductor layer, and the drain electrode, and is supplied to the pixel electrode 151. Each TFT 156 is disposed in the region in which the pixel electrode 151 is cut out.

The drain wiring line 155 is provided to extend from the drain electrode of the TFT 156 toward the center of the pixel electrode 151. In addition, the line has a region, which is expanded in a certain range, at and around the center of the pixel electrode 151, and is connected to the pixel electrode 151 through the contact hole 157 provided in the insulation film within the corresponding region.

The auxiliary capacitance (CS) bus line 154 extends in the place, in which the line overlaps with the extension region of the drain wiring line 155, with the insulation film interposed therebetween, and a certain amount of the auxiliary capacitance is formed between the drain wiring line 155 and the CS bus line 154. Each CS bus line 154 has a slight difference in view of picture element units, but extends in the row direction so as to have a substantially linear shape in the whole range. In addition, a part of each CS bus line 154 extends to the vicinity of the position of the gap between the pixel electrodes 151 arranged in the row direction, and extends in the column direction so as to cover the gap between the pixel electrodes 151.

In Reference Example 4, in a similar manner to Example 1, the two source bus lines 152, through which image signals are supplied to the pixel electrodes 151, are disposed to overlap with the pixel electrode 151 having the larger area between the two pixel electrodes 151 which are arranged in the row direction. One of the two source bus lines 152 is connected to one of the pixel electrodes 151 arranged in the row direction through the TFT 156, and the other one is connected to the other one of the pixel electrodes 151 arranged in the row direction through the TFT 156. In Reference Example 4, the areas of the pixel electrodes 151a arranged in the left side column in the pixel are larger than the areas of the pixel electrodes 151b arranged in the right side column, and both of the two source bus lines 152 overlap with the pixel electrodes 151a arranged in the left side column. In addition, the left side source bus line 152a is connected to the pixel electrodes in the left side column through the TFTs 156a, and the right side source bus line 152b is connected to the pixel electrode 151b in the right side column through the TFTs 156b. All the source bus lines 152 are formed in a substantially linear shape without having any large curve.

However, in Reference Example 4, the configuration of the stripe array is adopted. Hence, the overlapping areas between the pixel electrodes 151 and the source bus lines 152 in the single pixel are large compared with Example 1. Hence, compared with Example 1, deviation of the monochromatic luminance increases, and the tinge shift tends to occur. Further, since the length of each picture element in the row direction is small, particularly the pattern density of the source bus lines 152 is high, and thus it is concerned about deterioration in yield ratio. Furthermore, in Reference Example 4, the aperture ratio is low compared with Example 1, and the configuration thereof does not include a high luminance color (for example, yellow (Y) or white (W)), and thus it is difficult to secure a sufficient transmissivity compared with the case of Example 1.

### Reference Example 5

A display panel according to Reference Example 5 is an example of a conventional liquid crystal display panel in which four colors of red (R), green (G), blue (B), and white (W) are arranged in a stripe shape. The ratio of the actual aperture areas in each picture element is red (R):green (G):blue (B):white (W)=1:1:1:1.

FIG. 19 is a schematic plan view illustrating an example of a wiring structure of an active matrix substrate of a display panel according to Reference Example 5. As shown in FIG. 19, in the display panel according to Reference Example 5, the pixel electrodes 161 are arranged in matrix, and a region, in which the four pixel electrodes 161 are arranged in the row direction, constitutes a single pixel.

In Reference Example 5, the gate bus lines 163, through which gate signals are supplied, extend in the row direction so as to cover the gaps between the pixel electrodes 161 arranged in the column direction, and each of the lines is connected to TFTs 166.

The gate electrode of the TFT 166 is connected to the gate bus line 163, the source electrode is connected to the source bus line 162, and the drain electrode is connected to the pixel electrode 161 through the drain wiring line 165. At the timing of supplying the gate signal to the gate electrode, the image signal is transferred in order of the source electrode, the semiconductor layer, and the drain electrode, and is supplied to the pixel electrode 161. Each TFT 166 is disposed in the region in which the pixel electrode 161 is cut out.

The drain wiring line 165 is provided to extend from the drain electrode of the TFT 166 toward the center of the pixel electrode 161. In addition, the line has a region, which is expanded in a certain range, at and around the center of the pixel electrode 161, and is connected to the pixel electrode 161 through the contact hole 167 provided in the insulation film within the corresponding region.

The auxiliary capacitance (CS) bus line 164 extends in the place, in which the line overlaps with the extension region of the drain wiring line 165, with the insulation film interposed therebetween, and a certain amount of the auxiliary capacitance is formed between the drain wiring line 165 and the CS bus line 164. Each CS bus line 164 has a slight difference in view of picture element units, but extends in the row direction so as to have a substantially linear shape in the whole range. In addition, a part of each CS bus line 164 further extends to the vicinity of the position of the gap between the pixel electrodes 161 arranged in the row direction, and extends in the column direction so as to cover the gap between the pixel electrodes 161.

In Reference Example 5, in a similar manner to Example 1, the two source bus lines 162, through which image signals are supplied to the pixel electrodes 161, are disposed to overlap with the pixel electrode 161a having the larger area between the two pixel electrodes 161 which are arranged in the row direction. One of the two source bus lines 162 is connected to one of the pixel electrodes arranged in the row direction through the TFT 166, and the other one is connected to the other one of the pixel electrodes 161 arranged in the row direction through the TFT 166. In Reference Example 5, the areas of the pixel electrodes 161a arranged in the left side column in the pixel are larger than the areas of the pixel electrodes 161b arranged in the right side column, and both of the two source bus lines 162 overlap with the pixel electrodes 161a arranged in the left side column. In addition, the left side source bus line 162a is connected to the pixel electrodes 161a in the left side column through the TFTs 166a, and the right side source bus line 162b is connected to the pixel electrode 161b in the right side column through the TFTs 166b. All the source bus lines 162 are formed in a substantially linear shape without having any large curve.

However, in Reference Example 5, the configuration of the stripe array is adopted. Hence, the overlapping areas between the pixel electrodes 161 and the source bus lines 162 in the single pixel are large compared with Example 1. Hence, compared with Example 1, deviation of the monochromatic luminance increases, and the tinge shift tends to occur. Further, since the length of each picture element in the row direction is small, particularly the pattern density of the source bus lines 162 is high, and thus it is concerned about deterioration in yield ratio.

### Evaluation Test 2

Hereinafter, the results of the evaluation test for verifying deviation of the monochromatic luminance in Example 1 and Reference Example 2 are shown. In Evaluation Test 2, the dot reversal driving in which a polarity is set to be reversed for each pixel is employed.

In the following Table 2, the applied voltage, the input luminance (the luminance determined on the basis of the input signal), the monochromatic effective value, the monochromatic luminance, and the difference (deviation of the monochromatic luminance relative to the input luminance) are collected.

TABLE 2

| | | Example 1 | | | Reference Example 2 | | |
|---|---|---|---|---|---|---|---|
| Applied | Input | Monochromatic | Monochromatic | | Monochromatic | Monochromatic | |
| voltage (V) | luminance (%) | effective value | luminance (%) | Difference | effective value | luminance (%) | Difference |
| 0.0 | 0.0 | 0.0 | 0.0 | — | 0.0 | 0.0 | — |
| 2.0 | 0.027 | 2.0 | 0.022 | −20% | 1.9 | 0.018 | −35% |
| 2.5 | 8.5 | 2.4 | 6.1 | −29% | 2.4 | 4.3 | −50% |
| 3.0 | 38 | 2.9 | 33 | −12% | 2.9 | 29 | −23% |
| 3.5 | 65 | 3.4 | 61 | −6.5% | 3.3 | 58 | −12% |
| 4.0 | 82 | 3.9 | 80 | −2.7% | 3.8 | 78 | −5.7% |
| 4.5 | 91 | 4.4 | 90 | −1.9% | 4.3 | 89 | −2.8% |
| 5.0 | 96 | 4.9 | 95 | −1.1% | 4.8 | 94 | −1.7% |
| 5.5 | 99.9 | 5.4 | 98 | −0.57% | 5.3 | 98 | −0.97% |
| 6.0 | 100 | 5.9 | 100 | −0.33% | 5.8 | 99 | −0.89% |

As shown in Table 2, in any of Example 1 and Reference Example 2, the luminance is reduced compared with the luminance determined on the basis of the input signal, but the degree of reduction in the luminance of Reference Example 2 is 1.5 to 2.0 times larger than that of Example 1. Further, there is a difference of 10% or more therebetween in gray scale. Consequently, according to Example 1, compared with the case of Reference Example 2, it is possible to more precisely display signal information. The values shown in Table 2 are slightly different depending on the used liquid crystal materials, but tend to be substantially the same.

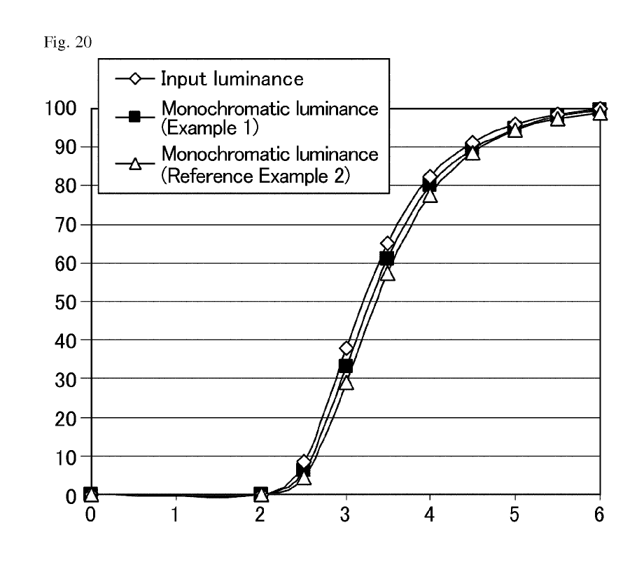

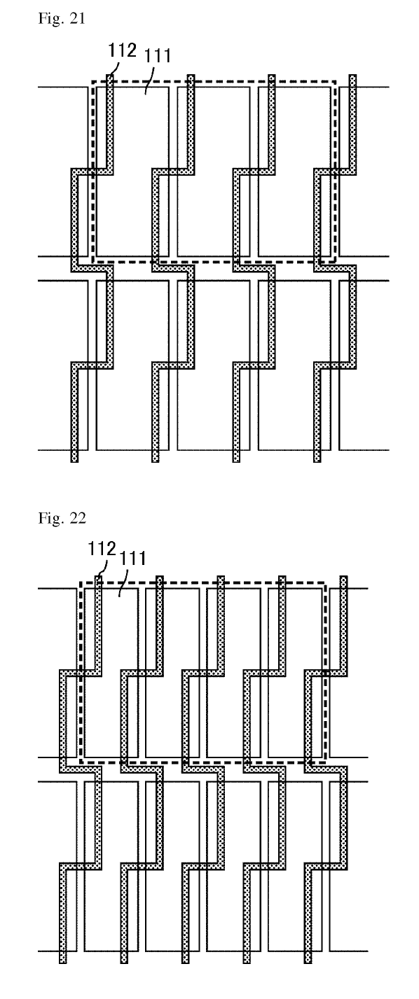

Further, FIG. 20 shows a graph based on the results of Table 2. As shown in FIG. 20, the deviation of the luminance determined by the input signal in Reference Example 2 is large compared with Example 1. In particular, the luminance deviation is large in gray scale, and thus has a great effect on the display.

The calculation results of the change in monochromatic luminance in Example 1 and Reference Example 2 are represented as follows. As described above, the amount of the change in the drain electric potential of the pixel electrode is calculated by (1) ΔVdr1=ΔVa1×Csd1/Cpix, (2) ΔVdr2=ΔVa2×Csd1/Cpix, (3) ΔVdr3=ΔVa3×Csd1/Cpix, and (4) ΔVdr4=ΔVa4×Csd1/Cpix. The (1) to (4) have an effect on the drain electric potential of the displayed image, and the potential is reduced compared with the electric potential to be originally recorded. The inventors of the present invention verify the following facts: the value calculated by Csd1/Cpix is 0.023 in Example 1, and is 0.040 in Reference Example 2. As a result, when 6.0V is applied, the value is 5.86V in Example 1, and is 5.76V in Reference Example 2, and thus it is observed that drain electric potential is decreased more in Reference Example 2 compared with Example 1.

The present application claims priority to Patent Application No. 2010-251322 filed in Japan on Nov. 9, 2010 under the Paris Convention and provisions of national law in a designated State, the entire contents of which are hereby incorporated by reference.

### REFERENCE SIGNS LIST

11, 21, 31, 41, 111, 121, 131, 141, 151, 161: pixel electrode
11a, 21a, 31a, 41a, 151a, 161a: pixel electrode having larger area
11b, 21b, 31b, 41b, 151b, 161b: pixel electrode having smaller area
12, 22, 32, 42, 112, 122, 132, 142, 152, 162: source bus line
12a, 22a, 32a, 42a, 152a, 162a: source bus line (self-pixel-electrode bus line) connected to pixel electrode having larger area
12b, 22b, 32b, 42b, 152b, 162b: source bus line (other-pixel-electrode bus line) connected to pixel electrode having smaller area
13, 23, 33, 43, 123, 133, 143, 153, 163: gate bus line
14, 24, 34, 44, 124, 134, 144, 154, 164: CS bus line
15, 25, 35, 45, 125, 135, 145, 155, 165: drain wiring line
16, 26, 36, 46, 126, 136, 146, 156, 166: TFT (thin film transistor)
16a, 26a, 36a, 46a, 156a, 166a: TFT connected to pixel electrode having larger area
16b, 26b, 36b, 46b, 156b, 166b: TFT connected to pixel electrode having smaller area
17, 27, 37, 47, 127, 137, 147, 157, 167: contact hole
18, 28, 38, 48, 128, 138, 148, 158, 168: rivet
19, 29, 39, 49: photo spacer

1. A display panel comprising:
signal lines;
pixel electrodes; and
a common electrode,
wherein a single pixel is constituted by picture elements of four or more colors,
wherein each of the pixel electrodes is connected to each one of the signal lines,
wherein the pixel electrodes, which are included in the single pixel, are arranged in a squared shape, and include a pixel electrode having larger area and a pixel electrode having smaller area, and
wherein both of a signal line connected to the pixel electrode having the larger area and a signal line connected to the pixel electrode having the smaller area overlap with the pixel electrode having the larger area.

2. The display panel according to claim 1, wherein a polarity of an electric potential of the pixel electrode having the larger area and a polarity of an electric potential of the pixel electrode having the smaller area are opposite to each other with reference to an electric potential of the common electrode.

3. The display panel according to claim 1,
wherein the pixels is formed in matrix on the display panel, and
wherein respective electric potentials of the pixel electrodes, which are included in the single pixel of the pixels and are adjacent in a row direction, are different from respective electric potentials of the pixel electrodes at the same positions included in a pixel adjacent to the single pixel, with reference to the electric potential of the common electrode.

4. The display panel according to claim 1,
wherein the pixels is formed in matrix on the display panel, and
wherein any of electric potentials of the pixel electrodes, which are included in the single pixel of the pixels, is different from electric potential of the pixel electrodes at the same positions included in a pixel adjacent to the single pixel respectively, with reference to the electric potential of the common electrode.

5. The display panel according to claim 1, wherein a length of a portion, in which at least one of the signal lines overlaps with one of the pixel electrodes, is shorter than a length of a longest portion of the pixel electrode in the same direction.

6. The display panel according to claim 1,
wherein the number of the pixel electrodes, which are included in the single pixel, is 2n (n is a natural number), and the pixel electrodes are formed of n pixel electrodes having the larger areas and n pixel electrodes having the smaller areas,
wherein the n pixel electrodes having the larger areas are respectively arranged in the same direction, and
wherein the n pixel electrodes having the smaller areas are arranged in a direction different from that of the n pixel electrodes having the larger areas.

7. The display panel according to claim 1,
wherein the number of the pixel electrodes, which are included in the single pixel, is 2n (n is a natural number), and the pixel electrodes are formed of n pixel electrodes having the larger areas and n pixel electrodes having the smaller areas, and
wherein the n pixel electrodes having the larger areas and the n pixel electrodes having the smaller areas are arranged in a checkered pattern shape in a row direction and a column direction.

8. The display panel according to claim 1,
wherein color filters are respectively formed to overlap with the pixel electrodes, and
wherein a magnitude of a luminosity of a color of the color filter which overlaps with the pixel electrode having the larger area is smaller than a magnitude of a luminosity of a color of the color filter which overlaps with the pixel electrode having the smaller area, in the single pixel.

9. The display panel according to claim 1,
wherein the color filters are respectively formed to overlap with the pixel electrodes, and
wherein an actual aperture area of the color filter which overlaps with the pixel electrode having the larger area are substantially the same as an actual aperture area of the color filter which overlap with the pixel electrode having the smaller area, in the single pixel.

10. The display panel according to claim 9, wherein each of the actual aperture areas of the color filters, which overlap with each of the pixel electrodes are substantially the same, in the single pixel.

11. The display panel according to claim 1, wherein the display panel is a liquid crystal display panel comprising a pair of substrates, which are formed of an active matrix substrate and a counter substrate, and a liquid crystal layer which is sandwiched between the pair of substrates.
